(19) United States
(12) Patent Application Publication
(10) Pub. No.: US 2016/0360160 A1
(43) Pub. Date: Dec. 8, 2016

(54) PERSON WEARABLE PHOTO EXPERIENCE AGGREGATOR APPARATUSES, METHODS AND SYSTEMS

(71) Applicant: CATCH MOTION INC., New York, NY (US)

(72) Inventor: Rom EIZENBERG, New York, NY (US)

(21) Appl. No.: 15/120,961

(22) PCT Filed: Feb. 23, 2015
(86) PCT No.: PCT/US2015/017139

§ 371 Date: Aug. 23, 2016

Related U.S. Application Data
(60) Provisional application No. 62/022,783, filed on Jul. 10, 2014.
(60) Provisional application No. 61/943,453, filed on Feb. 23, 2014.

(51) Int. Cl. H04N 7/18; G06Q 50/00; H04N 5/232; G06F 1/16; H04N 5/225; G06Q 30/02; G06F 17/30

(52) U.S. Cl. CPC H04N 7/185; G06Q 30/0241; G06Q 30/0207; G06Q 50/01; G06F 17/30268; G06F 17/3028; G06F 17/30864; G06F 1/163; H04N 5/2252; H04N 5/23206; H04N 5/23293; H04N 5/23245; H04N 5/232; H04N 5/23216

(57) ABSTRACT

The PERSON WEARABLE PHOTO EXPERIENCE AGGREGATOR APPARATUSES, METHODS AND SYSTEMS (“CMN”) may transform event creation and user experience media object generation inputs using CMN components into meta-tagged media objects and time-bounded, location-common social experience timelines. Apparatuses, methods, and systems herein describe capturing media using a wearable photo capture device which can use sensors to stabilize media capture, and/or can use the sensors to determine when to capture media. The wearable photo capture device can connect to an application on a mobile device for further functionality, including a social network (SN) feature which allows for creation of public and private Events for which a user (or, with permission from the user, additional users) can provide substantially live streams of media objects generated by the wearable photo capture device. The user can also, via the SN, interact with media objects created by other users and added to such Events.

This application for letters patent disclosure document describes inventive aspects that include various novel innovations (hereinafter “disclosure”) and contains material that is subject to copyright, mask work, and/or other intellectual property protection. The respective owners of such intellectual property have no objection to the facsimile reproduction of the disclosure by anyone as it appears in published Patent Office file/records, but otherwise reserve all rights.

### FIELD

The present innovations generally address the use of one or more photo and/or video capture devices in order to assist in the creation of a shared social experience, and more particularly, include PERSON WEARABLE PHOTO EXPERIENCE AGGREGATOR APPARATUSES, METHODS AND SYSTEMS.

However, in order to develop a reader's understanding of the innovations, disclosures have been compiled into a single description to illustrate and clarify how aspects of these innovations operate independently, interoperate as between individual innovations, and/or cooperate collectively. The application goes on to further describe the interrelations and synergies as between the various innovations; all of which is to further compliance with 35 U.S.C. §112.

### BACKGROUND

Cameras may be used by individuals to record or capture life moments and experiences for future recall. In many instances, the photos may be shared with others, such as by printing physical photos or emailing files to friends and family. Sometimes, such as when there is an event of interest to the public, multiple individuals will record and/or photograph the same or a similar subject.

### BRIEF DESCRIPTION OF THE DRAWINGS

The accompanying appendices and/or drawings illustrate various non-limiting, example, innovative aspects in accordance with the present descriptions:

FIGS. 1A-E show aspects of a design for an example CMN wearable photo capture device, in one implementation of the CMN operation;

FIG. 2 shows an example data flow illustrating aspects of wearable device photo capture and social experience aggregation, in one implementation of the CMN operation;

FIG. 3 shows an example data flow illustrating aspects of contextual meta-data tagging with temporal audio input, in one implementation of the CMN operation;

FIGS. 4A-B show an example user interface illustrating aspects of social experience retrieval, in one implementation of the CMN operation;

FIG. 5 shows an example logic flow illustrating aspects of cloud image upload package generation, e.g., an example CIU Component, in one implementation of the CMN operation;

FIG. 6 shows an example logic flow illustrating aspects of social experience timeline generation, e.g., an example SETG Component, in one implementation of the CMN operation;

FIG. 7 shows an example user interface illustrating aspects of CMN event creation, in one implementation of the CMN operation;

FIG. 8 shows an example user interface illustrating aspects of CMN event direction, in one implementation of the CMN operation;

FIG. 9 shows an example user interface illustrating aspects of a CMN dynamic remote viewfinder, in one implementation of the CMN operation;

FIG. 10 shows aspects of an example hardware design for a CMN wearable photo capture device, in one implementation of the CMN operation;

FIGS. 11-20 show example CMN user interfaces, in one implementation of the CMN operation;

FIGS. 21A-D show example aspects of eInk surface matching for a CMN wearable photo capture device, in one implementation of the CMN operation; and

FIG. 22 shows a block diagram illustrating aspects of an exemplary embodiment of a CMN user interface controller, in one implementation of the CMN operation.

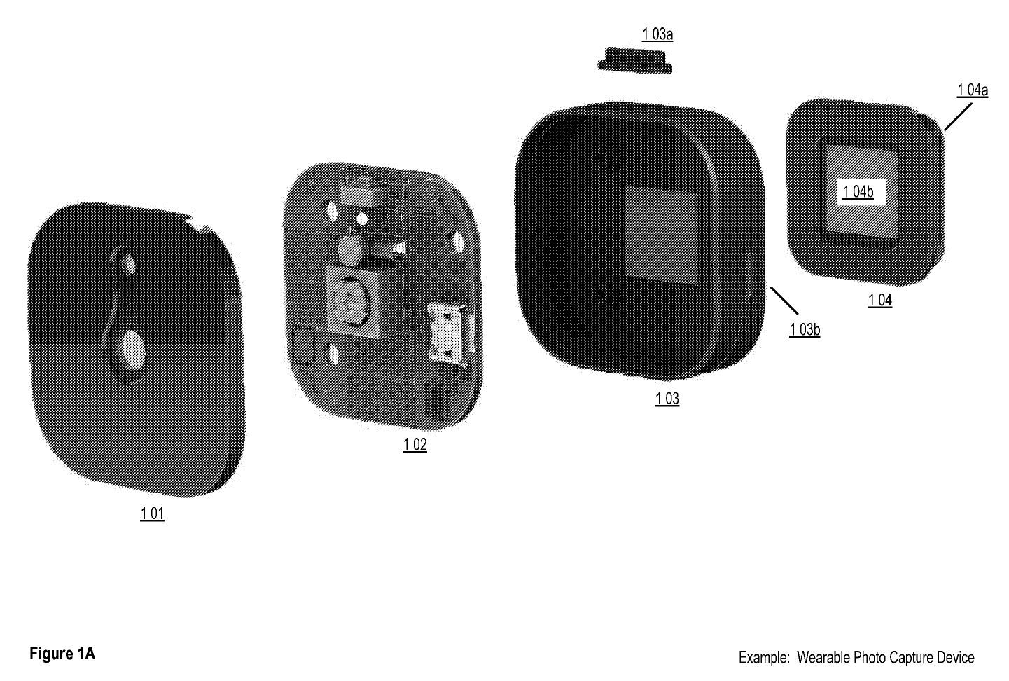

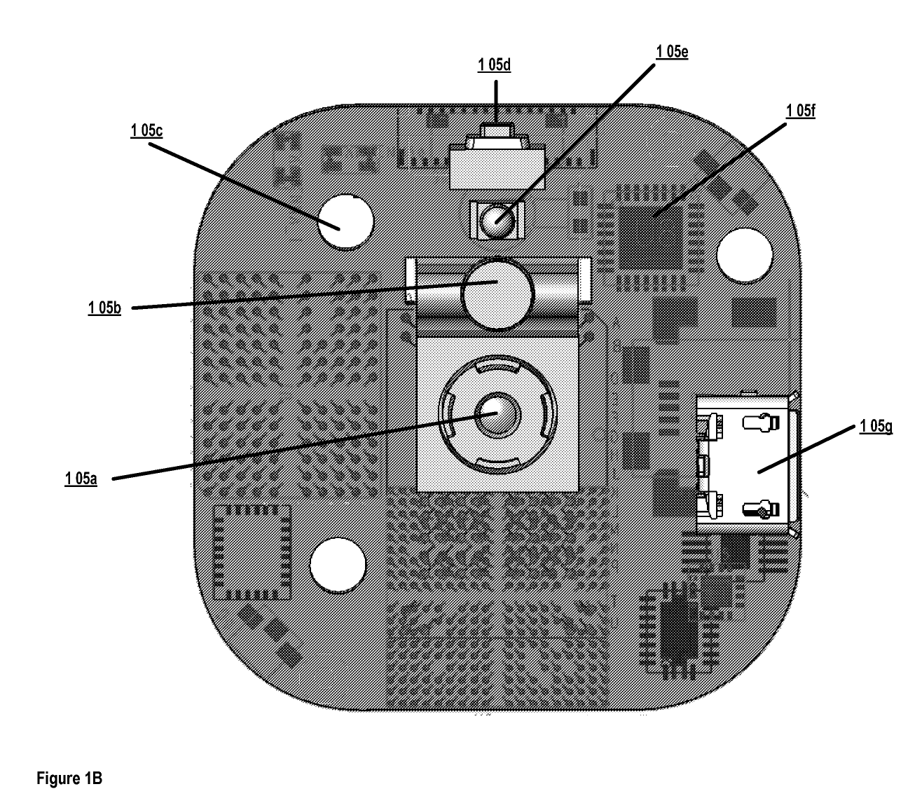

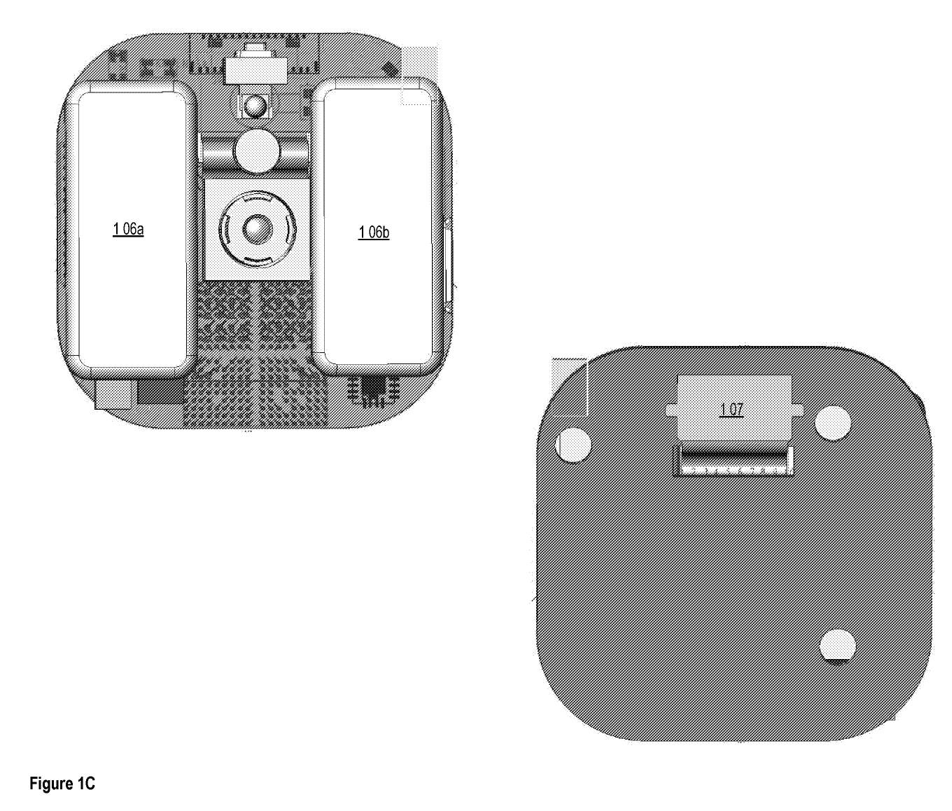

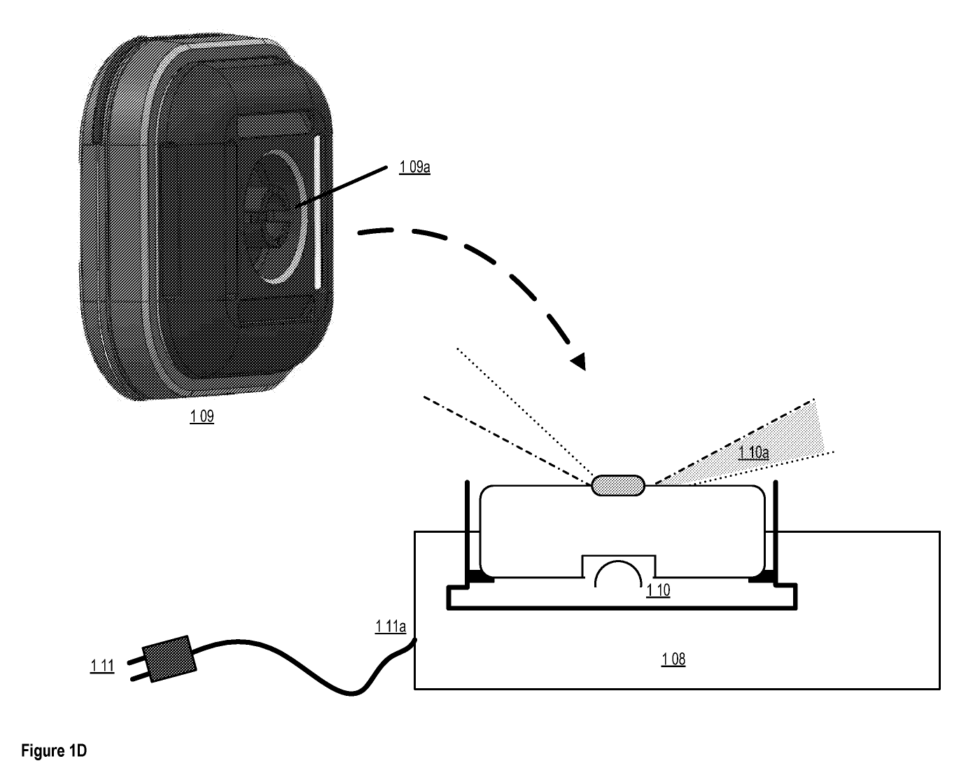

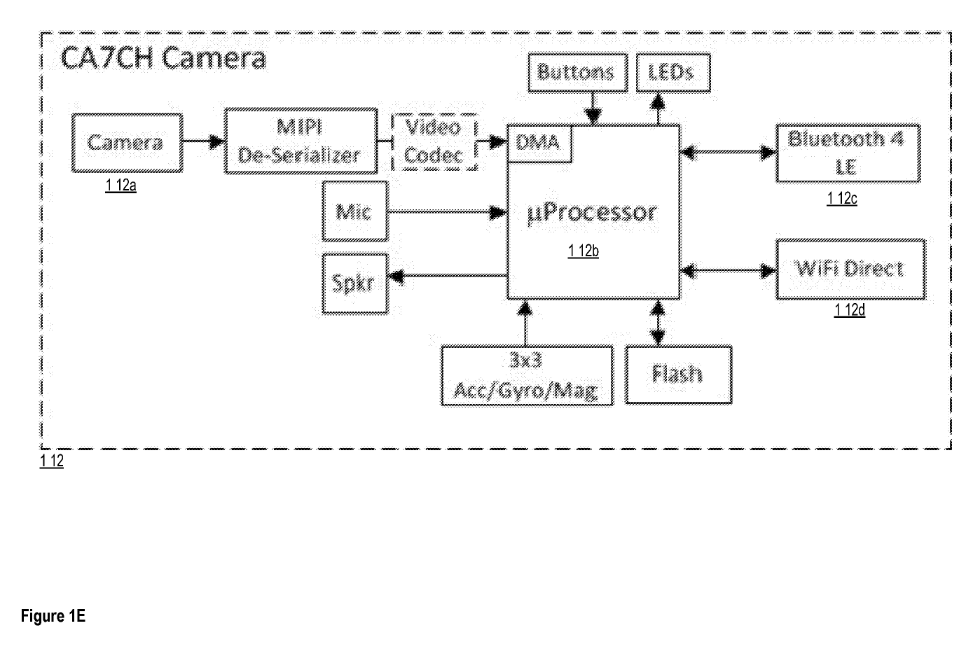

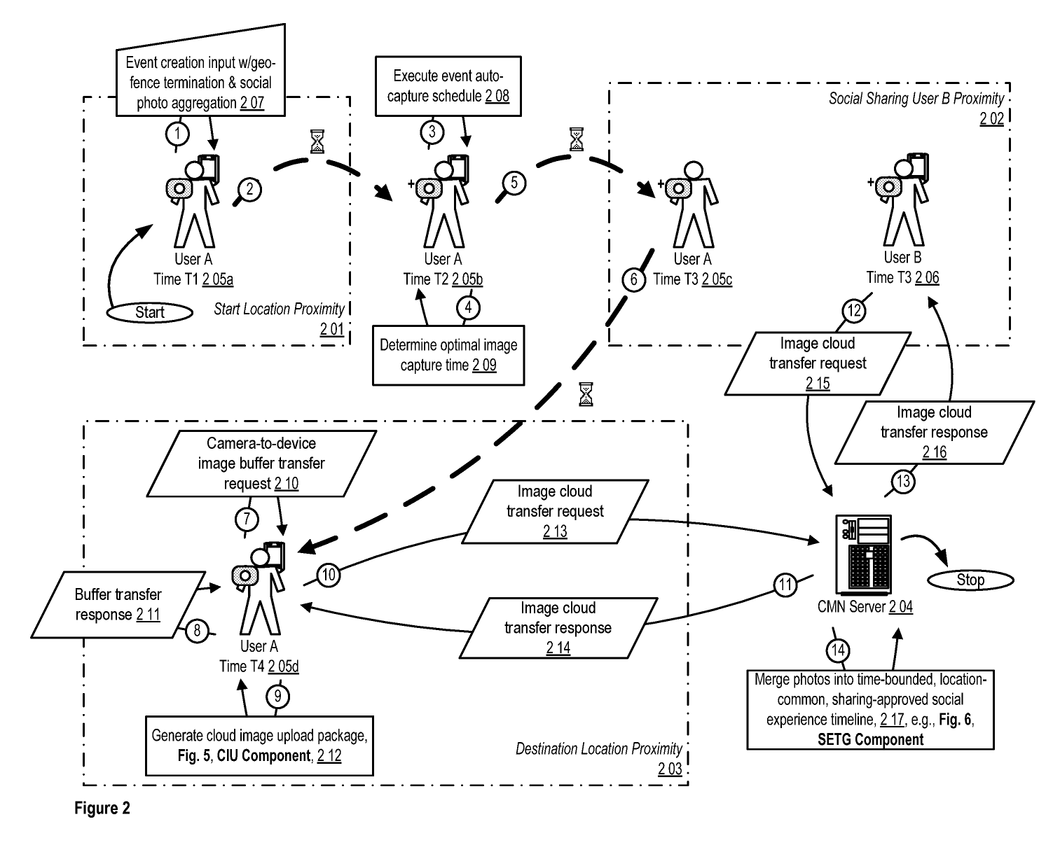

The leading number of each reference number within the drawings indicates the figure in which that reference number is introduced and/or detailed. As such, a detailed discussion of reference number 101 would be found and/or introduced in FIG. 1. Reference number 201 is introduced in FIG. 2, etc.

### DETAILED DESCRIPTION

### CMN

The PERSON WEARABLE PHOTO EXPERIENCE AGGREGATOR APPARATUSES, METHODS AND SYSTEMS (hereinafter “CMN” user interface) transforms user event and photo/video capture inputs into time-bounded, location-common, sharing-approved social experience timelines, via CMN components. In some embodiments, this is carried out in real time.

FIGS. 1A-E show aspects of a design for an example CMN wearable photo capture device (e.g., also referred to herein as a wearable device, a camera, a wearable camera device, and/or the like), in one implementation of the CMN operation. The wearable photo capture device, e.g., 101-103, may be configured such that one of a plurality of available device mounting accessories, e.g., 104, may be affixed via a magnetic coupling mechanism to the back of the wearable device and changed or substituted by the user to enable multiple mounting options. Example device mounting accessories are discussed herein. In one embodiment, the mounting surface of the wearable device may further form part of the mechanism for securing the wearable device to a charging station.

In one embodiment, the wearable device may contain a front-facing cover, e.g., 101. The front cover may be made of stamped aluminum or any other suitable formable material such as plastic injection molding, milled aluminum and/or the like. The cover can protect media capture element components (e.g., components of an element used to capture media such as images, videos, and/or the like). The media capture element components can form a media capture element, such as a camera, microphone, and/or a combination of the two. As shown, the front cover may have a centered first aperture forming an opening which may align with the camera lens described below. The front cover may additionally have a secondary aperture through which an LED flash may align. In one aspect of the described design, the first and second apertures may be recessed into the surface of the front cover, such recess being formed by the removal of a contiguous portion of some or all of the front cover surface. In one embodiment, the recess may be larger than the apertures for the camera lens and the LED flash and may accommodate, for example, an ambient light sensor. In alternative design embodiments, one or more additional apertures may be made on the wearable device's front cover to allow, for example, an infrared emitter for nighttime wearable device usage, a second camera suitable for stereoscopic imaging, and/or the like.

The front cover 101 may be configured such that it mates with a back element 103, which is formed with a recess suitable for mounting logic/component circuit board 102. When joined together, the front cover 101 and the back element 103 may mate together in a manner enclosing logic/component circuit board 102. Back element 103 may have one or more printed circuit board (e.g., “PCB”) mount posts for attaching board 102. In one embodiment, the back element 103 may contain a cut-out for a single button 103a which protrudes from back element 103 and is configured to provide physical input to a button sensor in communication with logic/component board 102, described further below. The single button's behavior may be configured by the user or may, for example, begin a default operation such as recording a video for 30 seconds and thereafter uploading the video to a user's social experience aggregation service described herein. The single button interface is made possible in part by the described design and additionally by the unique pairing of the wearable device and minimalist physical interface with a feature-rich smart phone application capable of selectively controlling and issuing commands to the wearable photo capture device via a wireless connection. Aspects of the physical/software paired user interface for the wearable device is discussed further below. In one aspect of the described design, the back element 103 may have a raised magnetic back surface 103b suitable for attaching one or more mounting accessories described below. The raised magnetic surface may correspond to a depression in a mounting accessory such that, when brought within a proximity, the wearable device and the mounting accessory may “snap” into alignment 29 with each other.

In one embodiment, the wearable photo capture device may mate with a mounting element 104 that is attachable and removable by the device end-user. As illustrated, mounting element 104 is a magnetic element that connects with device back element 103. The mount features a depression 104b corresponding to the raised distal surface of back element 103 and a spring clip 104a suitable for attaching the mounting accessory and a mated wearable camera device to the user (for example, by clipping the mated device and mounting accessory pair to the user's jacket lapel).

As an additional mounting option, a user may utilize mounting element 104 to attach the wearable device to their shirt, jacket and/or the like by placing the device 101-103 on the outside of their shirt and the mounting element 104 on the inside such that they form a temporary magnetic bond through the shirt in a manner that is easily removable and positionally flexible. Such a usage scenario would not functionally utilize clip 104a but would instead utilize the magnetic bond between the wearable device 101-103 and the mounting accessory 104 itself to facilitate securing the device. Furthermore, the removability of mounting accessory 104 allows for the attachment of other alternatively designed mounting accessories to back element 103. Example attachable mounts include but are not limited to a clip or clamp, an angled mount suitable for attaching to a user's hat brim, a tie-down, a magnetic mount that further includes a water resistant plastic element that encompasses the photo capture device such that only the mount is exposed when submerged in water, and/or the like.

With respect to FIG. 1B, an example layout for a printed circuit board containing one or more surface mounted components is shown. In one embodiment, camera element 105a may be center mounted on the board. The camera may be for example Sony/Omnivision model IMX179/OV8865. The board may further have mounted to it a microphone 105b such as for example Wolfson model WM7230/MP45DT02. The board may have one or more apertures cut out that correspond to the previously described PCB mounting posts, e.g., 105c. Further components may include push button sensor 105d, a LED indicator 105e, and a microprocessor 105f such as for example ST Micro model STM32F401. Further aspects of the board's design may include a physical interface 105g such as a USB port or the like as well as one or more flash memory modules, an MIPI Deserializer such as ST Micro model STMIPID02, a Bluetooth/WiFi direct chipset and antenna such as for example Broadcom model BCM43142, and a motion sensor and gyroscope component such as for example ST Micro model L3GD20.

With respect to FIG. 1C, an example internal location for the wearable device's battery component(s) is shown is shown, e.g., 106a-b, as well as a reverse view of PCB 102 showing a cutout allowing for attaching the camera module's interface to the side of the board opposite that on which the camera is mounted, e.g., 107.

With respect to FIG. 1D, an example charging station for the wearable device is shown, e.g., 108. In one aspect of the design, the wearable device 109 may attach to the charging station utilizing the previously described magnetic attachment system for mounting accessory coupling. The attachment mechanism for coupling the device to the charging station, e.g., 110, may have a rear interface with a ball joint allowing the camera to be tilted while in the charging station, e.g., 110a. By utilizing a 360 degree tilt capable mount for the wearable device, the camera may serve the role of for example a “nanny-cam” or baby monitor while in the charging station by utilizing the tiltable device/charger interface to point the camera to a desired monitoring location. The magnetic attachment plate for coupling the wearable device to the charging station, e.g., 109a, is enlarged and shown here separated from the charging station and attached to the wearable camera 109 to enhance the reader's understanding of the interface and tilt capabilities. In one embodiment, the attachment plate 109a is permanently attached to the charging station such that only wearable camera 109 separates from the charging station upon de-coupling the wearable device from the charging station. In one embodiment, the charging station is powered by standard 110V AC current in which is converted to 5V DC current, e.g., 111a.

With respect to FIG. 1E a logical diagram describing example components for PCB board 102 is shown, e.g., 112. In one embodiment, as described herein, the board may have a camera 112a, micro processor 112b, a wireless network element (e.g., wireless interfaces such as Bluetooth 4 LE 112C, WiFi direct 112d, and/or the like).

In some implementations, the wearable photo capture device can be waterproof (e.g., by design or can use nano-coating such as HzO-type technology) to allow for use of the wearable photo capture device in a variety of environments. In some implementations, the wearable photo capture device can be operated through use of a single button, which can be pressed multiple times in order to facilitate a number of actions. For example, 1 press may snap a picture, presses in quick succession may start voice recording (whereas the next press may stop voice recording), 3 presses in quick succession may start video recording (whereas the next press may stop video recording), and a 3-second press may turn the wearable photo capture device off (whereas a 1-second press may turn the wearable photo capture device on). The wearable photo capture device can also be configured to use audio and/or flash cues to indicate to the user when a function has been selected, when the wearable photo capture device is about to start capturing media, when the wearable photo capture device has completed capture of media, when the wearable photo capture device has connected to a mobile device, and/or for other such functions.

In some implementations, the wearable photo capture device can be connected to a web and/or mobile application (also referred to herein as an application and/or user interface) running on a mobile device (e.g., a smart phone, a tablet, a personal digital assistant, and/or the like, running iOS, Android, Windows Phone, Palm, and/or a similar operating system) which can allow a user to access and/or modify portions of his media captured by the wearable photo capture device. The application can both act as the conduit and control mechanism for the wearable photo capture device, and can facilitate a social media portal for the user. For example, when an authenticated wearable photo capture device is near a mobile device, the application may automatically facilitate a connection with the wearable photo capture device, e.g., via Bluetooth and/or Wi-Fi. Additionally, the social media functionality of the application can provide a user with access to his social graph, those of friends and family and public graphs.

The application can support WiFi Direct, 802.11 b/g network connections, and/or other such connections. Network connections may be configured by the application. The application can use o 5.6 GHz support Wireless for notification, configuration and command exchange between the wearable photo capture device and its user interface in the application, transfer of pictures to the application, video streaming for view-finder purposes, video streaming for storage and sharing (video recording), and/or similar actions. Wireless technology supported may include Bluetooth, WiFi, or a combination thereof. The wearable photo capture device can also support direct connection, e.g., through a local WiFi network to the CMN, to bypass the application. In this case, a mobile device running the application can act as the wearable photo capture device's interface and can trigger the wearable photo capture device to take pictures via the CMN connectivity. WiFi connectivity through an access point may be set in the application's user interface (e.g., using user/password and auto-connect settings).

A CMN-wearable photo capture device connection may be defined through association between a user and a wearable photo capture device identifier. The wearable photo capture device may auto-connect after the user's initial pairing with the mobile device and/or the CMN. The initial pairing may work when both the wearable photo capture device and the mobile device are in pairing mode, or may trigger when the mobile device is in pairing mode, regardless of a pairing mode setting on the wearable photo capture device. The application may initiate a connection after the initial pairing. The user may provide a wearable photo capture device ID to the application to facilitate the pairing. Power consumption for the wearable photo capture device may differ under different user configurations of the auto-connect feature.

In some implementations, the wearable photo capture device may work in at least three modes: mobile device-controlled mode, a programmed mode, and a manual mode. In a phone-controlled mode, the wearable photo capture device may stream real-time video feeds to the viewfinder on the mobile device, e.g., when the user activates the viewfinder on the mobile device. The wearable photo capture device can facilitate these feeds through a local direct connection between the wearable photo capture device and the mobile device (e.g., via a local network connection), and/or through a remote connection, e.g., wherein the wearable photo capture device and the mobile device connect via the application and/or via the CMN. In some implementations, if the devices connect via the CMN, the CMN may use the identifier of the wearable photo capture device and the identifier of the mobile device, as well as user account information, to match the devices together, and to forward communications being sent between them. The wearable photo capture device may start capturing media (e.g., may take a picture and/or start video recording) according to user feedback through the application on the mobile device. Picture resolution and/or flash may be used, and similar parameters may be set within the application by the user. In programmed mode, the wearable photo capture device may be configured using the application to capture media for a user-set duration of time. Picture resolution, flash use ii and similar parameters may be set within the application.

When in programmed mode, the wearable photo capture device can determine a time to capture media, e.g., within a second window from the user-specified timer, based on acceleration and stability (i.e. the wearable photo capture device may wait a second to take a more stable picture, depending on a current acceleration of the wearable photo capture device, in order to take the picture when acceleration conditions have improved for capturing the photo). In some implementations, the wearable photo capture device may not take a picture if light conditions are below a threshold (e.g., below a value that may result in completely black or otherwise non-recoverable image), regardless of whether the user-specified duration of time is close to ending, and/or whether the wearable photo capture device has captured any media during the time period.

When in manual mode, the user may capture media on the wearable photo capture device manually, e.g., by pressing the button on the wearable photo capture device. If the wearable photo capture device is not in range and/or otherwise connected to a mobile device and/or the CMN, the wearable photo capture device can store the captured media locally and later provide the media to a paired mobile device and/or the CMN as soon as it re-connects (e.g., once the mobile device is within range and/or the wearable photo capture device is connected to the CMN).

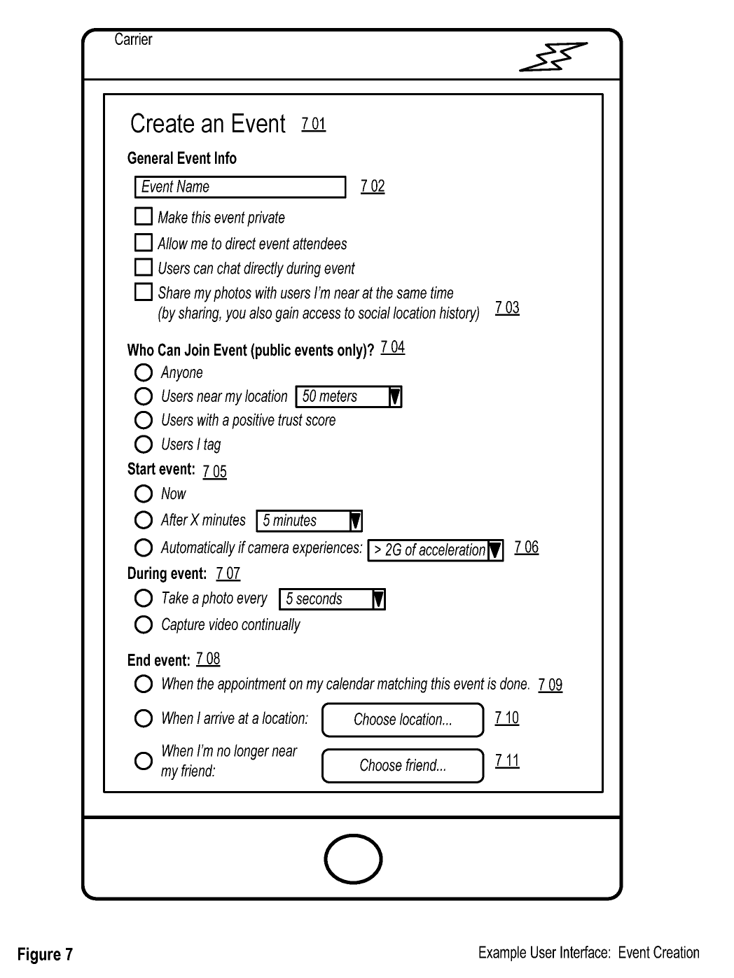

FIG. 2 shows an example data flow illustrating aspects of wearable device photo capture and social experience aggregation, in one implementation of the CMN operation. In one embodiment, a user 205a at an initial time T1 in an initial geographic proximity 201 may initiate an event creation input with a geo-fence automatic event termination and enabled social photo aggregation, e.g., 207. In one embodiment, the event input may be an input using the user's mobile device which may thereafter establish a wireless connection to a user wearable photo capture device such as that described above. Further detail regarding a user interface suitable for initiating and configuring an event may be found herein and particularly with respect to FIG. 7.

In one embodiment, the user may indicate in their event setup and configuration input 207 that they wish for a photo to be taken at a certain time interval until the end of the event. As such, when the user leaves the starting proximity 201, e.g., 205b, an auto-capture schedule may proceed to run automatically on the user's wearable device, e.g., 208. In one embodiment, the wearable device may automatically determine an optimal time to take the next in the series of photo, video or audio objects for the event, e.g., 209. In such an embodiment, the user-chosen time quantum may be adjusted up or down by the device in order to choose an optimal time of photo capture. For example, if a user has selected a 30 second photo interval during an event and at event time 30 seconds the camera is temporarily facing a dark wall, the device may determine this (such as, for example, using an ambient light sensor to determine available light) and delay the photo capture by seconds in order to potentially capture a better photo. In other embodiments, the device delay may be much shorter than 1 second. For example, if an in-device accelerometer determines that the camera is shaking (such as may be the case when a user is walking), the device may determine a capture delay such as 50 ms determined such that the user will be in the middle of a step and at the most stable point in a stride to capture a photo. The delay may be determined instantaneously, over a period (such as when the device determines a stride interval based on the last seconds of accelerometer data), or based on historical information about the user or device location. In another embodiment, when setting up an event, the user may request that the device notify the user if the conditions for photo capture remain sub-optimal for an extended period of time. This may be the case if the user inadvertently removes the device and puts it in his/her pocket during an event. The device may then in one example establish a Bluetooth connection with the user's smart phone and push an “alert” to the phone to remind the user of the on-going event. In still other embodiments, the device may make an auditory sound such as a beep in order to alert the user to persistent sub-optimal photo conditions.

In one embodiment, during the progression of the event yet before the event termination, the user 205c may enter a proximity, e.g. 202, at a time when another CMN user 206 is in substantially the same location. Although unaware of one another, user 205c and user 206 may nevertheless both experience a location within a proximity to one another at approximately the same time. Therefore, CMN user 206 may, if their privacy settings allow, have valuable media of social interest to user 205c and vice versa.

Upon reaching the destination location proximity 203, e.g. 205d, the event definition established earlier may cause the user wearable device to cease capturing photos and/or videos. In one embodiment, the wearable device may utilize its integrated onboard storage during an event to queue photos for later transmission to the user's mobile device. In other embodiments, the user device may transmit in substantially real-time any captured media to the user's mobile device. In still other embodiments, the wearable device may utilize an integrated Wi-Fi capability to upload media to a CMN social experience aggregation service whenever the device is in range of an accessible Wi-Fi network. In such an implementation, the wearable device may therefore receive an event definition from a user's mobile device yet utilize a different media object upload vector such as direct Wi-Fi upload to push locally stored media objects into the CMN. In a different embodiment, the CMN may be configured to push an event creation command to a user's wearable device when the device is accessible over WiFi but specify in the event definition that the media objects should be transmitted using the user's mobile device connection. Many other command-control/media object transfer configuration embodiments are available utilizing the CMN including non-wireless implementations whereby media objects are only transmitted via a direct wearable device connection such as USB (for example, to minimize user mobile device bandwidth usage), periodic scheduled transfers, peer-to-peer (e.g., wearable device to wearable device direct transfer), and/or the like. As an example alternative media object transfer configuration, for example, the CMN may be configured such that the user wearable device utilizes as a default transmission vector such as one described above, but has a rollover or fallback transmission vector that may be instantiated by the user wearable device automatically if certain conditions are met. For example, the CMN may be configured such that the wearable device transfers cached media objects and metadata utilizing a periodic once-an-hour schedule. However, a CMN user may in one embodiment configure the wearable device such that should the device sense a high rate of deceleration from its integrated accelerometer, then cached media objects will be immediately transferred utilizing any available transmission vector and a new event instantiated to capture and transmit real-time video. Such a configuration may be advantageous, for example, in the case of a car accident whereby the wearable device user is incapacitated. In such a scenario, the transmission of potentially life-saving media objects containing details about the accident or the user's injuries may be of paramount importance.

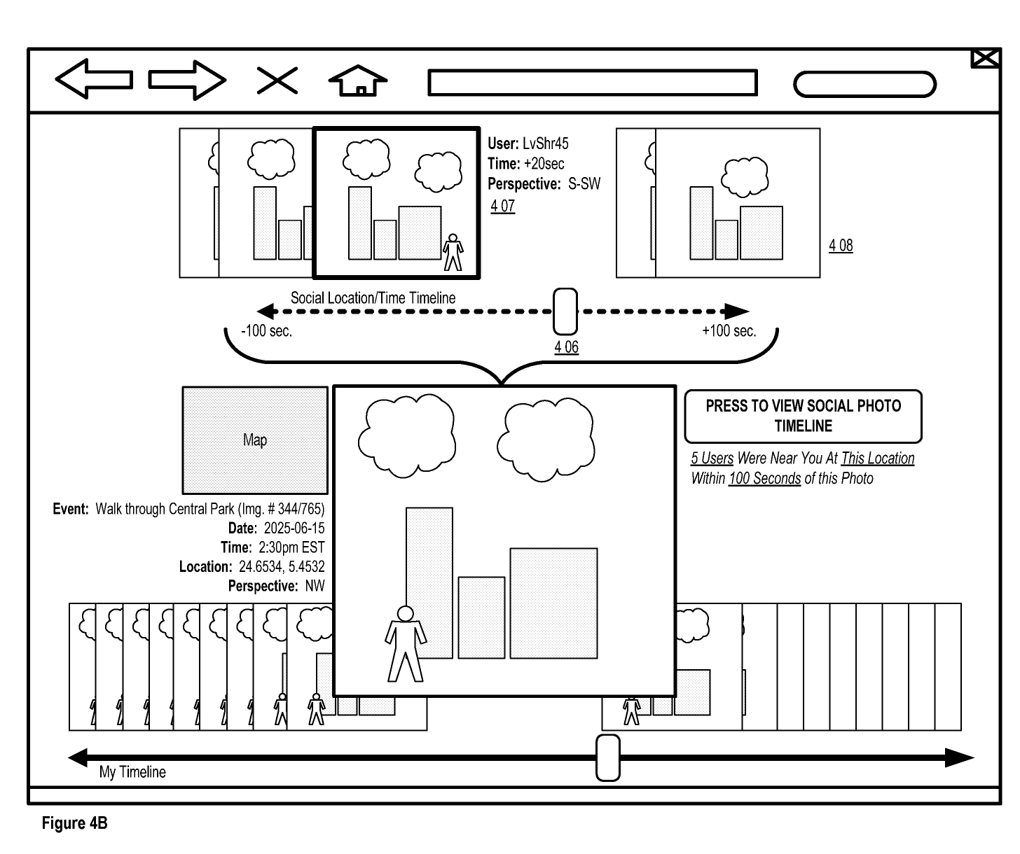

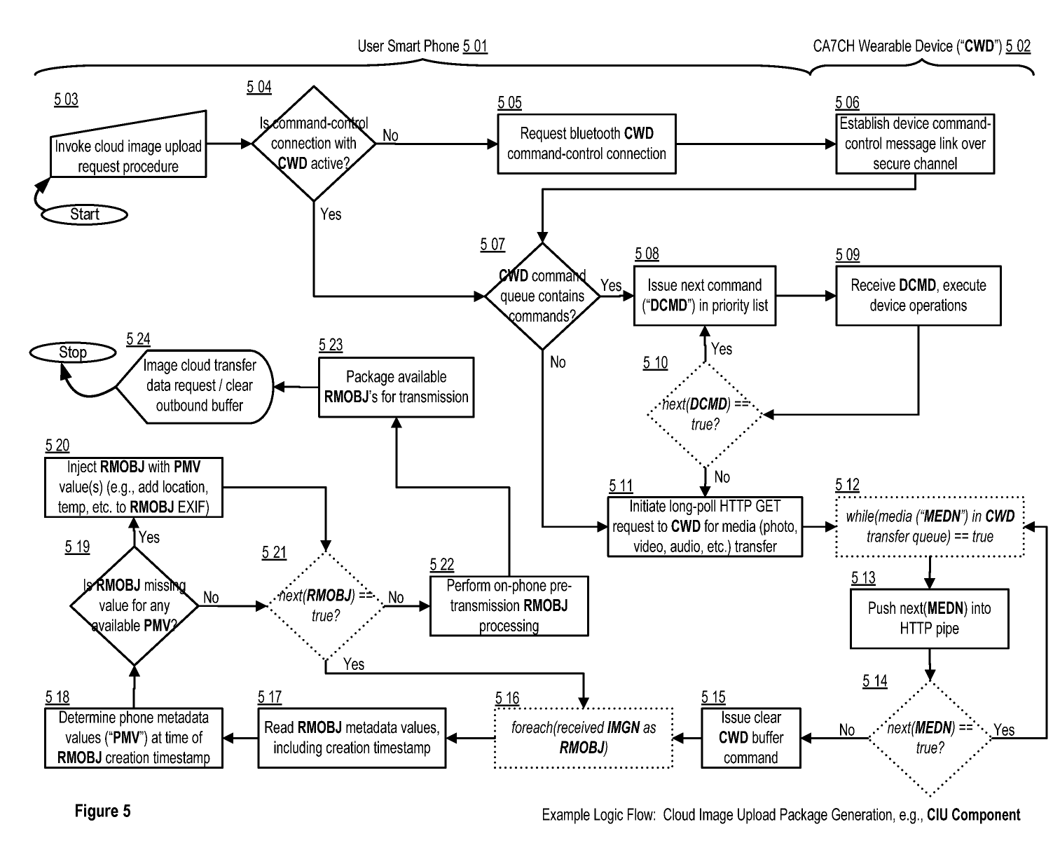

In one embodiment, in a CMN configuration whereby the wearable device is configured to utilize the user's mobile device for media object transport, the user's mobile device may, for example, determine based on the user's current location 203 that a configured event has ended. The mobile device may then initiate a request to the wearable device in order to retrieve media objects such as photos, videos or audio generated during the event, e.g. a camera-to-device image buffer transfer request 210. In one embodiment, the wearable device may thereafter provide its locally stored media objects, e.g. buffer transfer response 211, and the user mobile device may generate an upload package to transport the media objects and associated metadata captured both on the wearable device and using the user's smart phone to CMN server 204, e.g. 212. Further detail with respect to generating a cloud image upload package may be found herein and particularly with respect to FIG. 5, e.g. an example CIU component.

Upon generating the cloud image upload package, the user's mobile device may initiate an image cloud transfer request 213 to CMN server 204. An example image cloud transfer request 213, substantially in the form of an HTTP(S) POST message including XML-formatted data, is provided below:

```
POST /do_media_object_cloud_transfer.php HTTP/1.1
Host: www.CMNserver.com
Content-Type: Application/XML
Content-Length: 667
<?XML version = ″1.0″ encoding = ″UTF-8″?>
<media_object_cloud_transfer>
  <timestamp>2025-12-12 15:22:43</timestamp>
  <message_credentials type=″device_api_key″>
    <auth_key>h767kwjiwnfe456#niimidrtsxbi</auth_key>
  </message_credentials>
  <media_transfer count=″3″>
    <media_object num=″1″ type=″photo″>
      <metadata source=″wearable_device″>
        <temp val=″82deg″ />
        <acceleration>
          <x val=″.2G″ />
          <y val=″.15G″ />
          <z val=″.006G″ />
        </acceleration>
        <humidity val=″78%″ />
        <nearby_wifi_signals>
          <wifi ssid=″freecafewifi″ strength=″98%″ />
          <wifi ssid=″private″ strength=″65%″ security=″WPA2″ />
        </nearby_wifi_signals>
      </metadata>
      <metadata source=″user_smart_phone″>
        <location>
          <determined_by val=″user_smart_phone″ />
          <differential_objectTimeLocationTime val=″3sec″ />
          <lat val=″12.6543″ />
          <lon val=″14.6543″ />
        </location>
        <nearby_CMN_users>
          <user name=″johnShares″ detected_via=″Bluetooth″ />
          <user name=″EU7654″
            distance=″6m″
            detected_via=″CMN_service_poll_nearby_users″ />
        </nearby_CMN_users>
    </metadata>
    <object type=″binary_data″ format=″JPG″>
        ...
      </object>
    </media_object>
    <media_object num=″2″ type=″video″>
      ...
    </media_object>
    <media_object num=″3″ type=″audio″>
      ...
    </media_object>
  </media_transfer>
</media_object_cloud_transfer>
```

The CMN server may thereafter process the image transfer request and reply with an image cloud transfer response 214 indicating successful receipt of the media object metadata transfer. Thereafter, the user smart phone and/or the user wearable device may optionally purge their local storage of the transferred media objects. In one embodiment, upon transferring media objects from the wearable device to the user smart phone, the user wearable device will at that point purge transferred media objects. In an alternative embodiment, the user wearable device may retain media objects as storage space allows until receipt of a notification generated by CMN server 204 that the media objects have been successfully received and processed.

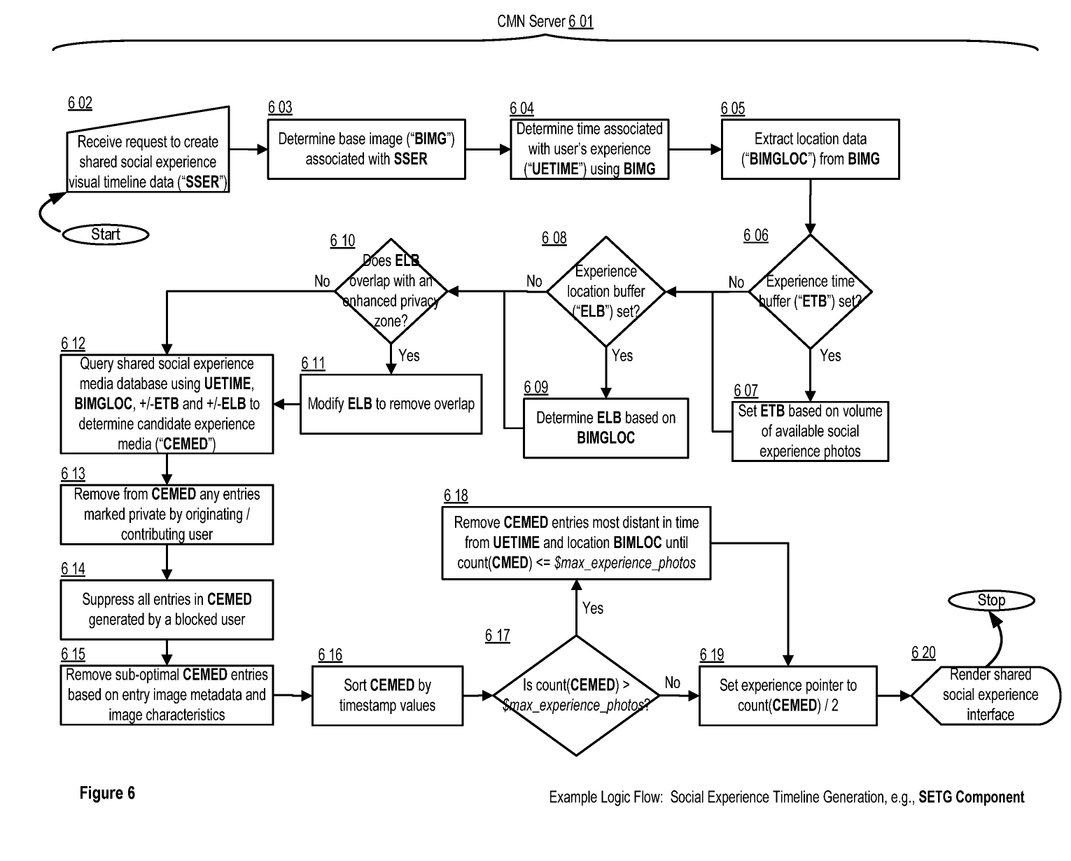

In one embodiment, at a time not necessarily synchronous with the user's image cloud transfer request/response 213-214, user 206 may similarly initiate an image cloud transfer request 215 to CMN server 204 and thereafter receive an image cloud transfer response 216. By acting as a central node, CMN server 204 may therefore asynchronously receive media objects generated by multiple user wearable devices and thereafter form connections between the user's experiences based on location, time, social experiences and connections, a media object marketplace value, and/or the like by providing access to a merged media object data set spanning multiple user's social experiences but maintaining individual user's privacy preferences, e.g. 217. Further detail with respect to merging media objects into a time-bounded location-common sharing-approved social experience timeline may be found herein and particularly with respect to FIG. 6, e.g. an example SBTG Component.

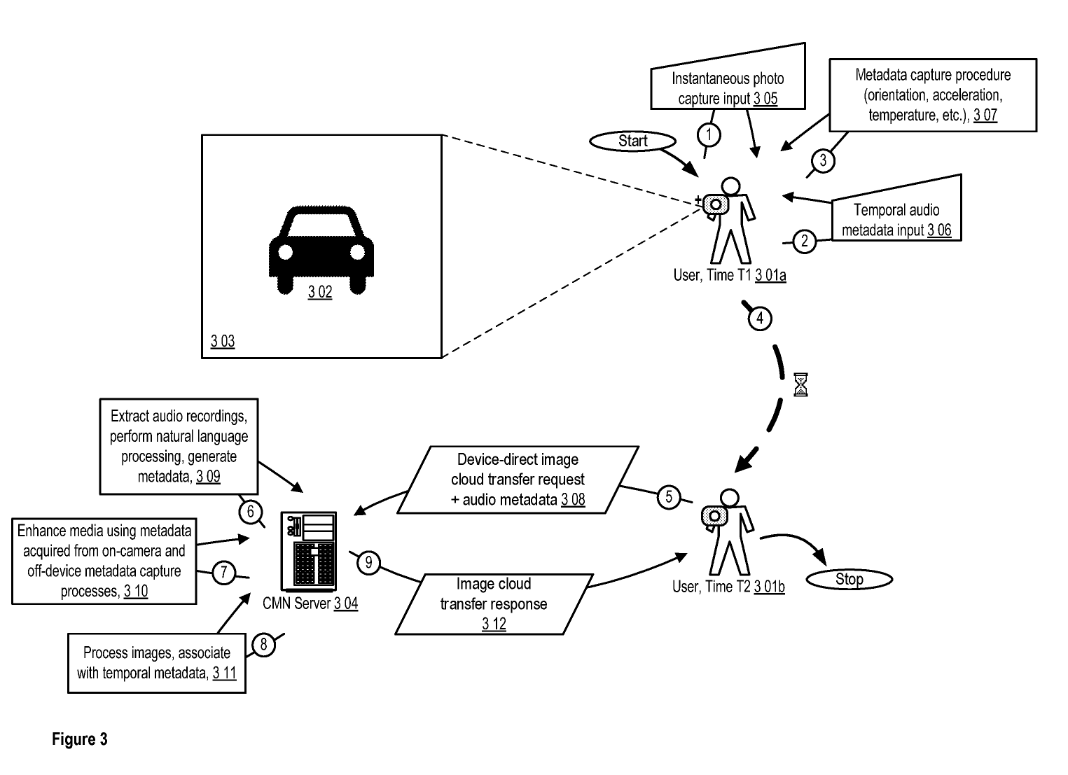

FIG. 3 shows an example data flow illustrating aspects of contextual meta-data tagging with temporal audio input, in one implementation of the CMN operation. In one embodiment, a user Sola at an initial time may initiate a request for their wearable photo experience aggregator device to capture a photo 303 of subject 302, e.g. an instantaneous photo capture input 305. The photo capture input may be, for example, the user pressing a button on the exterior of their wearable device. At substantially the same time as the instantaneous photo capture input 305, the user may provide an audio metadata input such as one describing the photo subject 302, audio to automatically create a future reminder on behalf of the user, descriptive keywords regarding the subject such as its color, speed, kind, and/or the like, e.g. temporal audio metadata input 306. In addition to the audio metadata input 306, the user wearable device may itself capture additional metadata such as the orientation of the photo, the current acceleration determined by an in-device accelerometer, temperature, aspects of the captured photos such as for example an average color density, and/or the like, e.g. 307. Furthermore, the wearable device may be paired with a user mobile phone that has access to additional metadata that is either not available or not gathered from or by the user wearable device. In so doing, the CMN may allow both the user wearable device and a user mobile phone such as a smart phone to both capture metadata which may be merged either on the wearable device or on the user smart phone. In one embodiment, at a time subsequent to the photo capture input, e.g. 301b, the user wearable device that has been configured to itself transfer media objects to the CMN may initiate a direct image cloud transfer request including the audio metadata input as well as additional metadata as described above when within range of an available WiFi network, e.g. 308. CMN server 304 may thereafter extract audio recordings from the media object metadata and perform automated natural language processing to generate textual metadata to be associated with the user experience capture, e.g. 309. Natural language processing libraries suitable for generating metadata from extracted audio recordings include Apache OpenNLP, Natural Language Toolkie (NLTK) and/or the like. In one embodiment, the CMN server 304 may thereafter enhance the received media object utilizing metadata received from on-device and off-device sources, e.g. 310. For example, utilizing metadata generated by the wearable device's integrated accelerometer, a video media object may be further processed by the CMN to reduce video shake. Similarly, such motion data may be utilized on a photo media object to reduce photo blur, orientation data may be utilized to automatically flip a photo to upright, temperature data may be utilized to determine a photo color temperature warming or cooling filter, and/or the like. Thereafter, the processed images may be associated with the metadata generated from the user's audio recordings, e.g. 311, and further processing based on the extracted audio text may be performed such as generating a reminder for the user based on the content of the audio metadata input 306. In one embodiment, CMN server 304 may thereafter issue image cloud transfer response 312 to the wearable device indicating that the media objects have been successfully received and processed and that the wearable device may purge its local copy of the media objects and the metadata audio to maximize user wearable device storage space.

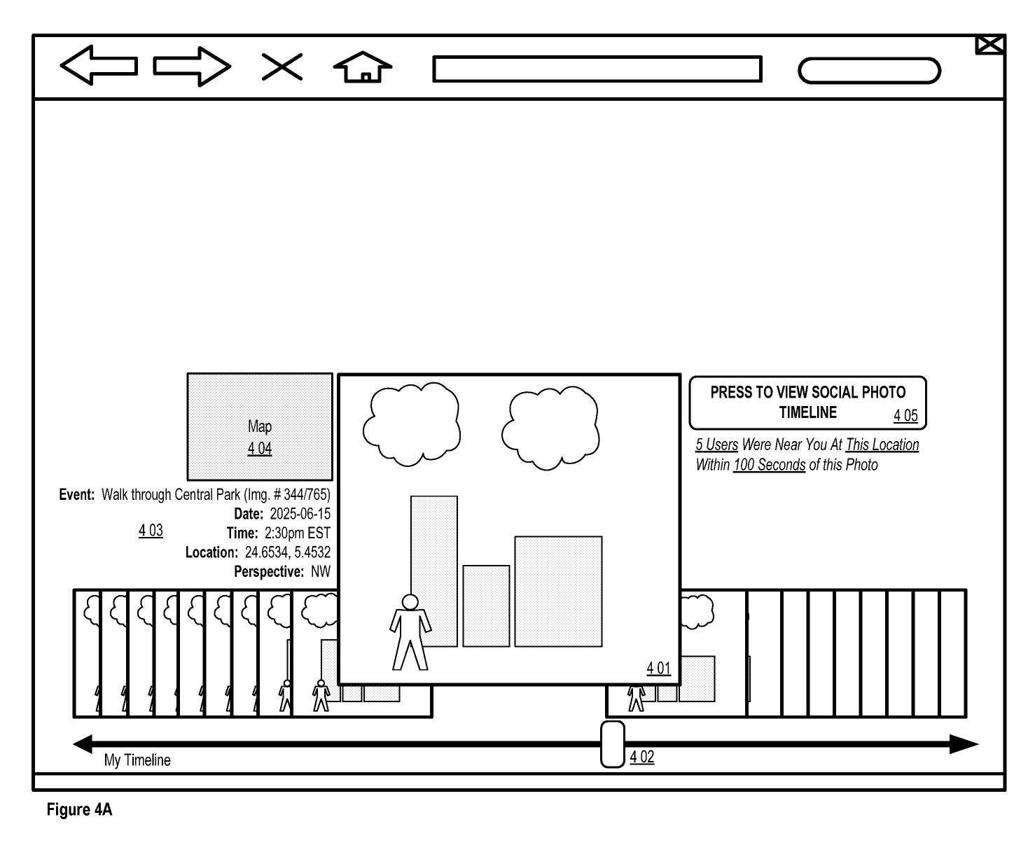

FIGS. 4A-B show an example user interface illustrating aspects of social experience retrieval, in one implementation of the CMN operation. In one embodiment, the CMN may provide a user interface allowing a user to browse their uploaded media objects, e.g. 401, and for one or more objects to access the social experiences of other CMN users. The user interface may provide an initial slider, e.g. 402, which the user may track along a timeline to view media objects they have uploaded in a chronological fashion. For each media object, selective information about the media object may be displayed, e.g. 403, such as the event that generated media object, the date and time the media object was captured, perspective information corresponding to the direction the wearable device was facing, and/or the like. As described above, in one embodiment, media objects may be supplemented by a user's mobile device location information corresponding to the location where the media object with generated. In so doing, the CMN may enable the user to view an interactive map, e.g. 404, corresponding to one or more of their media object captures. In one embodiment, upon viewing a media object 401, the user may press a button to view a social photo timeline associated with other users that were at substantially the same location as the user within a given time quantum, e.g. 405, and were also generating media objects.

With respect to FIG. 4B, upon invoking the request to view a social photo timeline, the user interface may provide a second slider, e.g. 406, allowing the user to view media objects uploaded near the location and time where the user's own media object was captured, e.g. 407. By manipulating slider 406, the user may view additional perspectives from multiple CMN users in a unified single interface, e.g. 408. Further detail with respect to creating and selecting content for the social experience view, e.g. 408, may be found herein and particularly with respect to FIG. 6, e.g. an example SETG Component.

FIG. 5 shows an example logic flow illustrating aspects of cloud image upload package generation, e.g., an example CIU Component, in one implementation of the CMN operation. In one embodiment, user smart phone 501 may receive inputs to invoke a cloud image upload request procedure, e.g. 503. If the smart phone does not have an available command-and-control connection with the user wearable device, e.g. 504, then a request may be sent to initiate a command-and-control connection such as one utilizing Bluetooth, e.g. 505. The wearable device 502 may thereafter establish a command-and-control message link with the user smart phone and await commands for processing, e.g. 506. If the paired smart phone 501 has commands to issue to the wearable device, e.g. 507, then the next command in the queue will be issued 508 and processed by the wearable device 509 until the queue has been exhausted, e.g. 510. In one embodiment, though suitable for command-and-control, a low bandwidth connection such as a Bluetooth connection may not be suitable for the rapid transfer of media objects from the wearable device to user smart phone 501. As such, an alternative wireless transfer mechanism may be utilized. For example, the user smart phone 501 may initiate a long poll HTTP GET request, e.g. a RESTful request, to the wearable device, e.g. 511. Upon establishing the connection, the wearable device may determine media objects that are awaiting transfer to user smart phone 501, e.g. 512, may proceed to transfer in a serial or parallel fashion the media objects, e.g. 513, until the wearable device's media object transfer queue is empty, e.g. 514. Thereafter, upon receipt of the media objects, user smart phone 501 may issue a request for the wearable device to clear it storage buffer of the transferred media objects, e.g. 515. For each media object received, e.g. 516, the smart phone may read the metadata values associated with the media object. Example meta-data values that may be provided by the wearable device include, but are not limited to, a timestamp associated with media object creation, temperature, orientation, altitude, humidity, approximate location, nearby Wi-Fi or cellular signals, active Bluetooth connections, the wearable device configuration at the time of the object capture, and/or the like. In one embodiment, the smart phone may thereafter determine additional metadata values that the smart phone is aware of and that would be related to some aspect of the media object capture such as the time of the media object capture, e.g. 518. If the received media object is missing any metadata value that can be provided by the user smart phone, e.g. 519, then the user smart phone may provide and/or inject the metadata value such that it becomes associated with the media object, e.g. 520. This supplementation of media object metadata may continue for each media object received, e.g. 521. Thereafter, the user smart phone may perform additional on-phone processing of media objects utilizing the received metadata, e.g., 522. For example, in one embodiment, the user's phone may reduce the accuracy of or otherwise manipulate the location metadata information associated with a media object if the media object is to be available and/or shared with other users. Such a capability may be utilized to protect a user's privacy by only revealing an approximate location of a media object capture. Additionally, in alternative embodiments, multiple copies of a single media object may in fact be generated to serve different purposes (e.g., one public object version and one private object version). In one embodiment, the user smart phone 501 may generate a transmission package containing the received and processed media objects, e.g. 523, and initiate an image cloud transfer data request and thereafter clear the local smart phone buffer of any successfully transmitted the objects, e.g., 524.

FIG. 6 shows an example logic flow illustrating aspects of social experience timeline generation, e.g., an example SETG Component, in one implementation of the CMN operation. In one embodiment, CMN server 601 may receive a request to create a shared social experience including visual timeline data for a user, e.g. 602. The CMN server may thereafter determine a base image associated with the request, such as the current image selected in the user interface, e.g. 603. The CMN may then determine a time associated with the user's experience, e.g. 604, such as by reading a time value associated with the selected media object. Additionally, the CMN may determine location data associated with the base image, e.g. 605. In some embodiments, since the probability is low that multiple user's wearable devices will report exactly the same time and location for a given experience media object despite the fact that the user's were in substantially the same location, an experience time buffer may be set, e.g. 606, and may be based on for example available social experience photos, e.g. 607. For example, if the CMN determines that for a given time period there is limited availability of socially shared media objects relevant to the user's base media object then the time window of search may be expanded. Furthermore, in scenarios where lots of media objects are available, the experience time buffer may be reduced. In one embodiment, the CMN may additionally utilize an experience location buffer, e.g. 608, to determine users that were in a proximity to the location associated with the media object generated by the user's wearable device, e.g. 609. Thereafter, CMN may determine whether the experience location buffer overlaps with an enhanced privacy zone, e.g. 610, such as may be set by the user or globally by a CMN administrator. For example, a user may desire to exclude any media objects generated while the user is in their home location even though the user's default social media object setting is public. If there is privacy zone overlap the CMN may modify the experience location buffer to remove the overlap, e.g. 611. In one embodiment, the CMN server 601 may thereafter query a shared social experience media database that contains objects provided by multiple users and multiple wearable devices. The query may be based on, for example, the time and/or location associated with the user's experience, the experience time buffer and/or spirit location buffer, media object metadata and/or the like, e.g. 612. From the retrieved candidate results, the CMN may remove any entries that are marked private by the originating or contributing user, e.g. 613. Furthermore, the CMN may suppress any entries associated with a user that the current user has indicated is a blocked user, e.g. 614. The CMN server may further remove sub-optimal media objects from consideration based on, for example, any aspect of the media object metadata, and/or characteristics of the media object, e.g. 615. For example, dark images or images with orientation or direction metadata inconsistent with the user's social media object search may be removed from consideration. Thereafter, the CMN may sort the candidate media objects by timestamp, e.g. 616. If the number of candidate images is greater than the maximum social experience photos requested or the maximum social experience photos viewable in the current user interface, e.g. 617, the CMN may remove candidate media objects that are most distant in time/location from the user's experience time/location until the number of media objects is less than or equal to the maximum number of experience photos required, e.g. 618. In so doing, the CMN may both cull the retrieved set of images based on global factors as described above and remove social experience media objects that may be less relevant to the user. Thereafter, in the example where the CMN is rendering a timeline view social experience such as that described herein with respect to FIG. 4, the CMN may set the pointer for the initial social media image in the ordered image set to be shown to the user to the photo that is that nearest in both time and location to the user's base media object used to initiate the search, e.g. 619. The CMN may then render a shared social experience timeline, e.g. 620, such as that described herein.

FIG. 7 shows an example user interface illustrating aspects of CMN event creation, in one implementation of the CMN operation. In one embodiment, the CMN may enable a user smart phone interface for event creation, e.g. 701. Aspects of configuring an event may include an event name 702, whether an event is private, whether the user desires to direct attendees in their behavior, whether user's associated with the event can chat during the event, whether the user desires to share photos captured using their wearable device with other users that are near the user at the same time, e.g. 703, and/or the like. In one embodiment, an event's attendees may be limited to users near the event location or the user's location, to users with a positive trust score, to tagged users, to users associated with a certain group such as for example law-enforcement, and/or the like, e.g. 704. The start of the event, e.g. 705, may occur immediately or after a time delay. In other embodiments, the start and/or end of an event may be associated with an environmental factor experienced by the user smart phone and/or the user wearable device such as, for example, an acceleration above a certain threshold automatically beginning an event, e.g. 706. In one embodiment, the user may configure the behavior of their wearable device during the event, e.g. 707, such as by indicating a time quantum at which photos should be captured, whether or not capture video, whether to only capture audio, and/or the like. An event configuration may additionally include one or more criteria to end an event, e.g. 708. For example, an event may automatically end when a corresponding smart phone calendar entry shows that the event is over, e.g. 709, when the user arrives at a given location, e.g. 710, or when the user is no longer near a friend, e.g. 711.

Further aspects of events and/or wearable device media object capture may allow the user to designate a subset of the public that has enhanced access to their generated wearable device media objects. For example, the user may indicate that law enforcement may automatically have access to otherwise private wearable device images if the user was in a proximity to a reported crime location at a relevant date/time. Furthermore, the user may indicate, for example, that media objects generated but not shared in a global fashion may be shared if the user receives compensation. For example, the user may configure a standing event such that when the user enters a given merchant, the merchant may receive a copy of any media objects generated by the user wearable device. The merchant may be interested in such media objects in order to analyze the media objects to determine patterns of user interest, product interest, store movement patterns, and/or the like. In exchange, a merchant may be willing to provide the user with a coupon for a discount on their purchase, an actual cash payment, and/or the like. In other embodiments, journalists may utilize a media object marketplace provided by the CMN in order to, for example, contact users that have media objects generated from their wearable devices at an important newsmaking event or time and offer the users compensation if the user is to willing to share or allow the media objects to be browsed or used in reporting.

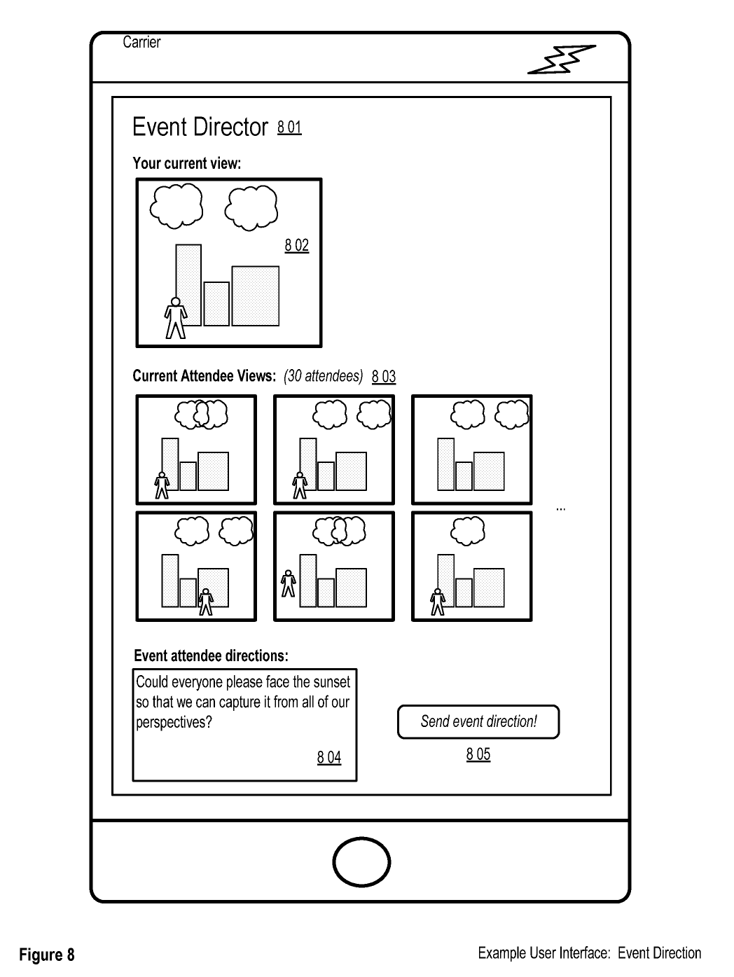

FIG. 8 shows an example user interface illustrating aspects of CMN event direction, in one implementation of the CMN operation. In one embodiment, during an event a user may indicate that they desire to direct the activities of other event attendees, e.g. 801. Such a user interface may allow the user to view their current wearable device viewfinder, e.g. 802, in addition to the views from event attendees, e.g. 803. The user may optionally type an event direction message, e.g. 804, such as a message requesting that all event attendees face a particular location so that the event may be captured simultaneously from multiple perspectives. The user may thereafter transmit the event direction, e.g. 805, simultaneously to all of the current event attendees.

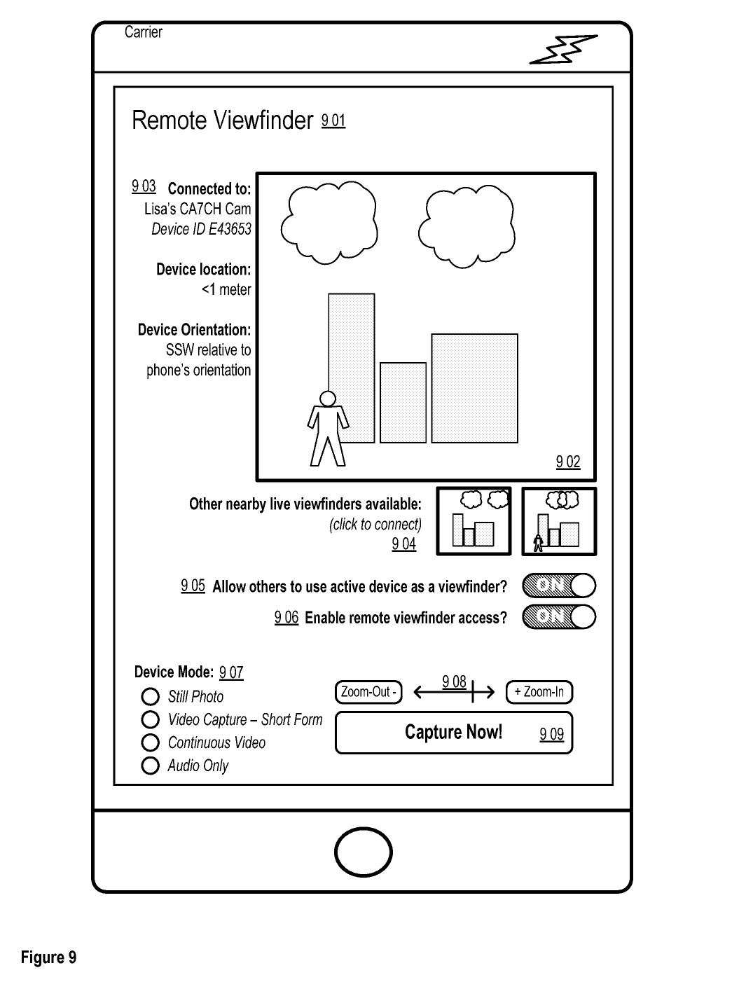

FIG. 9 shows an example user interface illustrating aspects of a CMN dynamic remote viewfinder, in one implementation of the CMN operation. In one embodiment, a user wearable device may be paired with a user smart phone in a manner that provides remote viewfinder capability, e.g. 901. A user may then use their smart phone to view the current wearable device's camera perspective, e.g. 902, and see details about the device including its location, orientation, and/or the like, e.g. 903. Furthermore, other remote viewfinders available to the user or that are nearby may be displayed, e.g. 904. In one embodiment, the user may allow their own wearable device to be used as a viewfinder by others, e.g. 905, or allow remote access to their device, e.g. 906. A remote viewfinder interface may additionally be used to, for example, set a device mode, e.g. 907, zoom in or out, e.g. 908, or initiate a media object capture, e.g. 909.

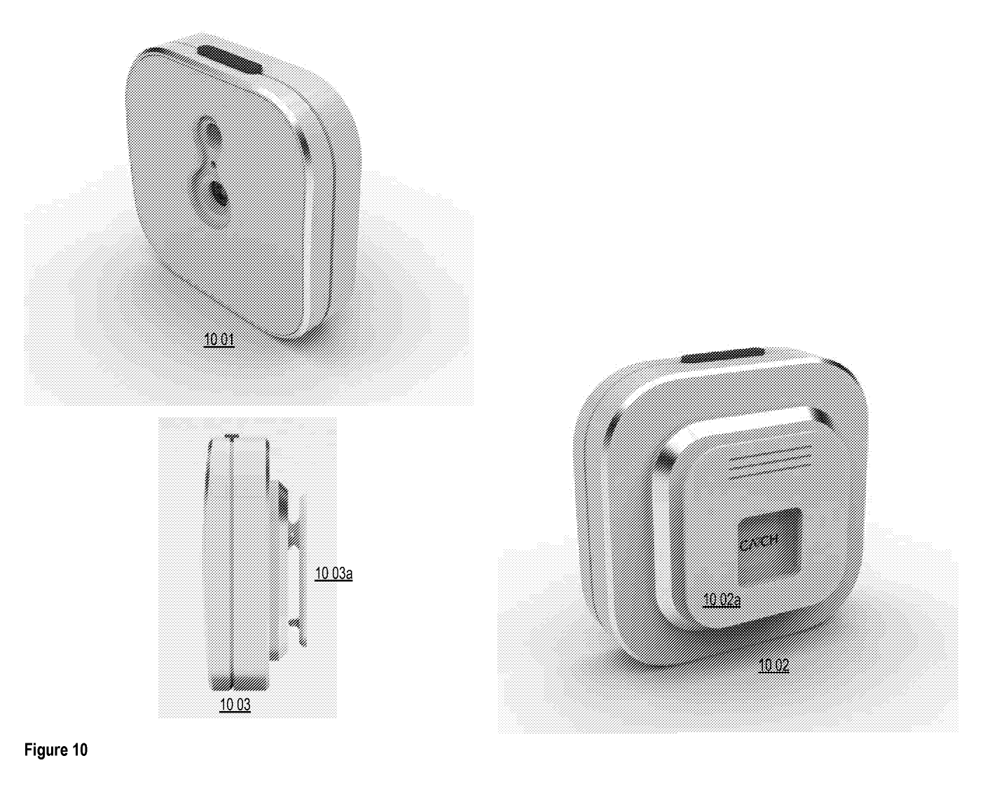

FIG. 10 shows aspects of an example design for a CMN wearable photo capture device, in one implementation of the CMN operation. In one embodiment, a front view 1001, three quarters view 1002, and side view 1003 for an example wearable media capture device is shown. With respect to the illustrated device, the magnetic mount attachment mechanism described above may be seen attached to a clip mount, e.g. 1002a, 1003a. As described above, the clip itself may be used to attach the device to an object. Alternatively, the clip mount accessory may be separated and placed inside of a user's shirt and be mated magnetically with the wearable device outside of the user shirt.

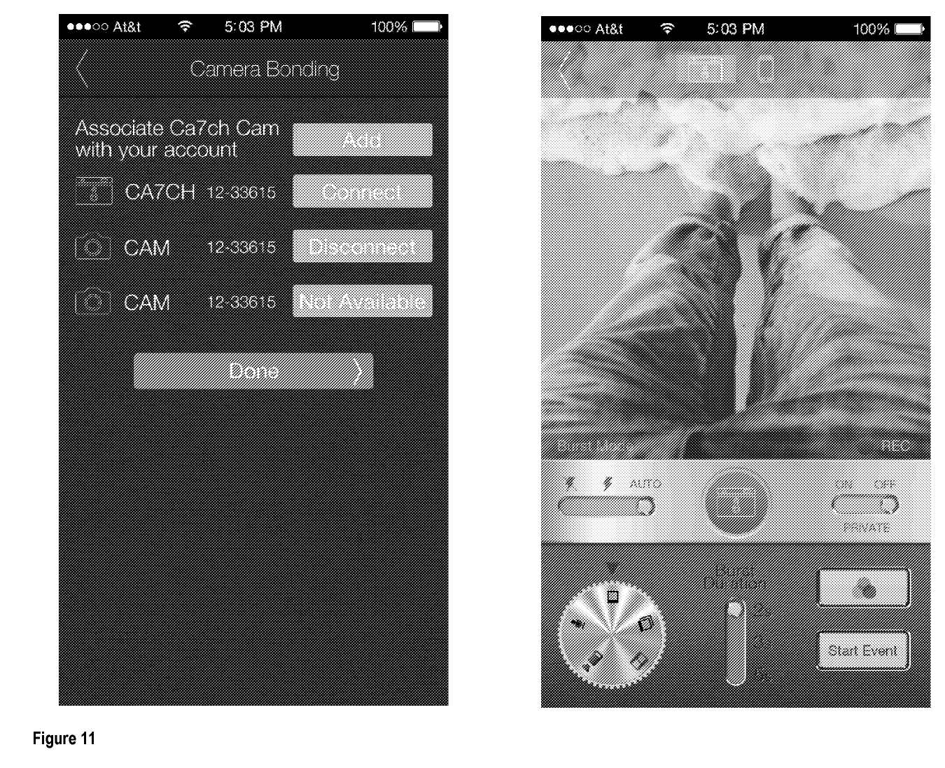

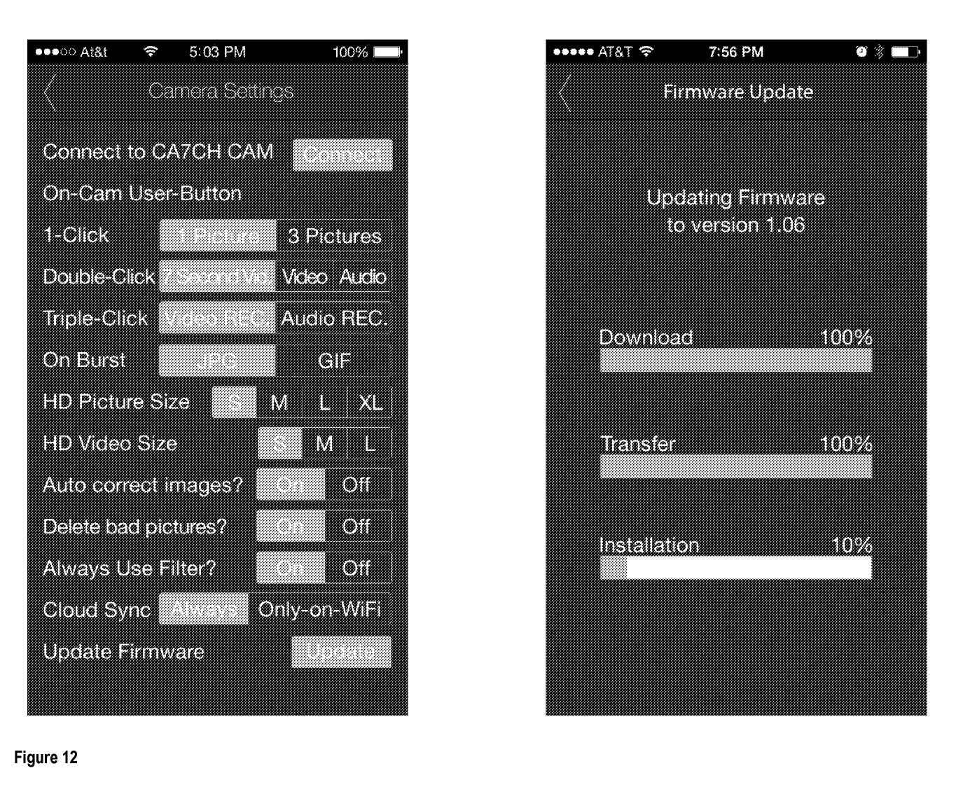

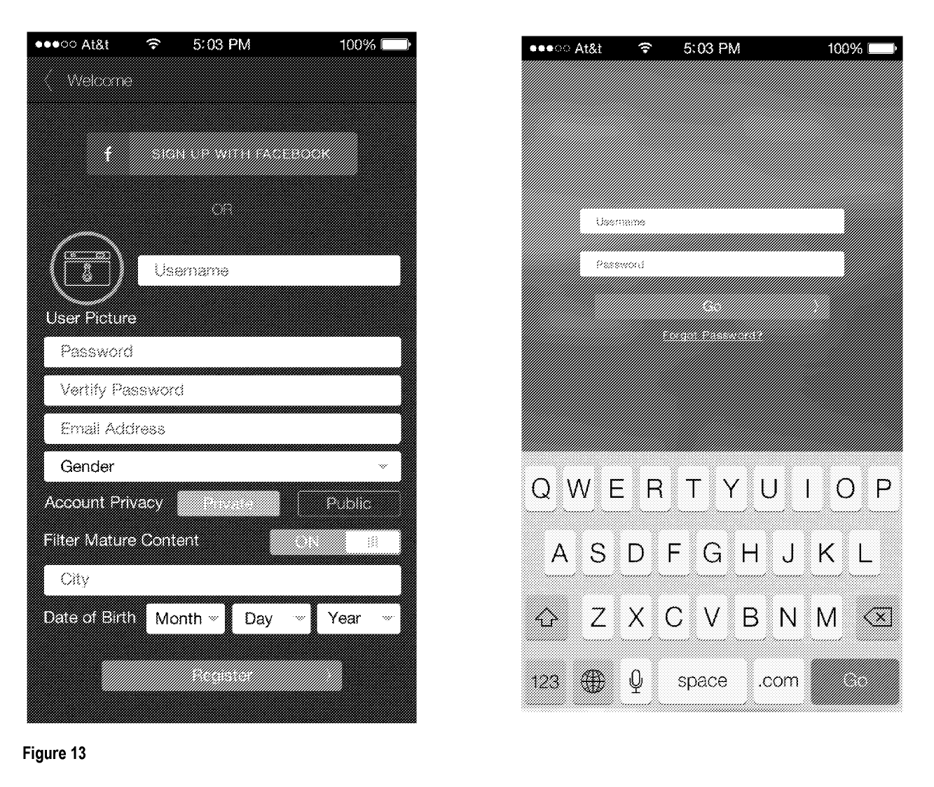

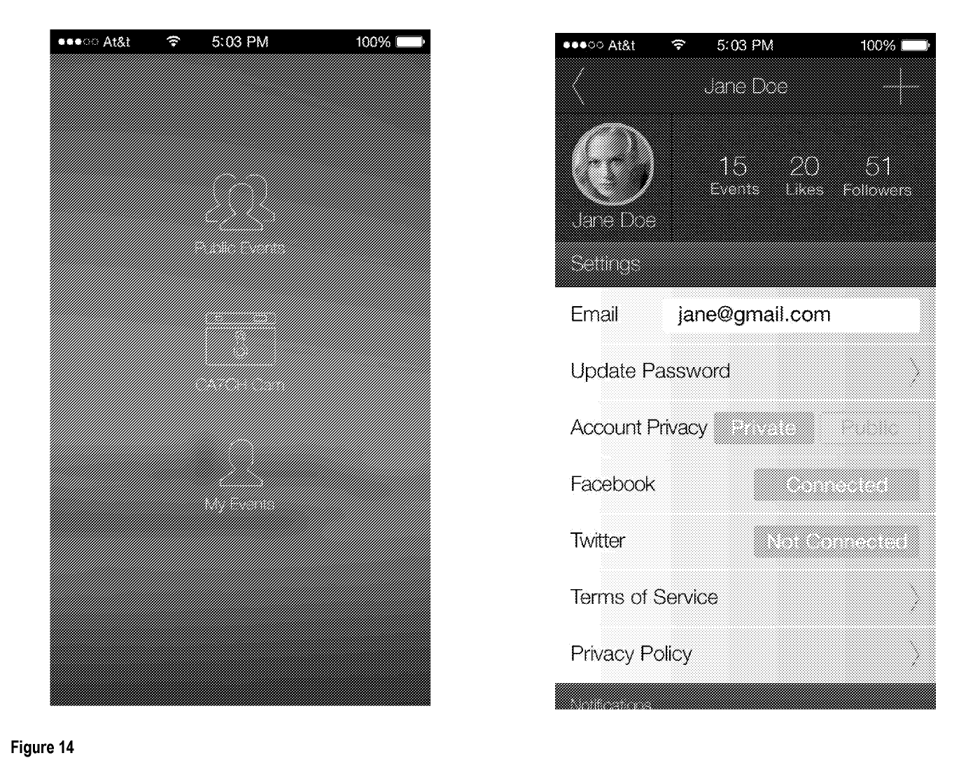

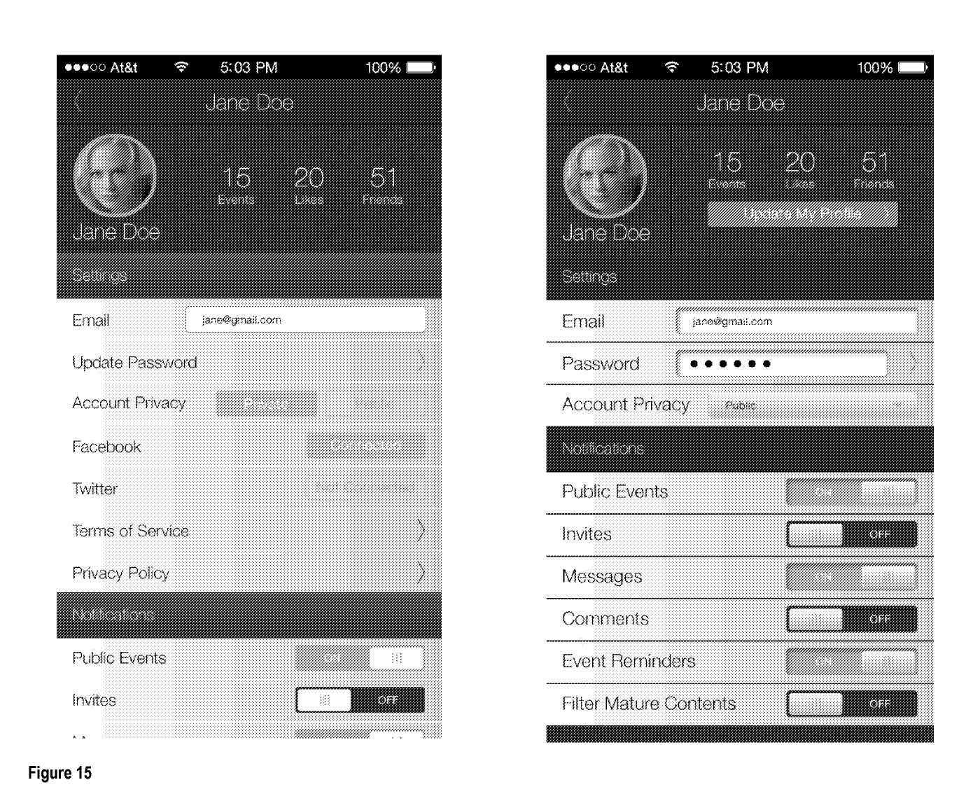

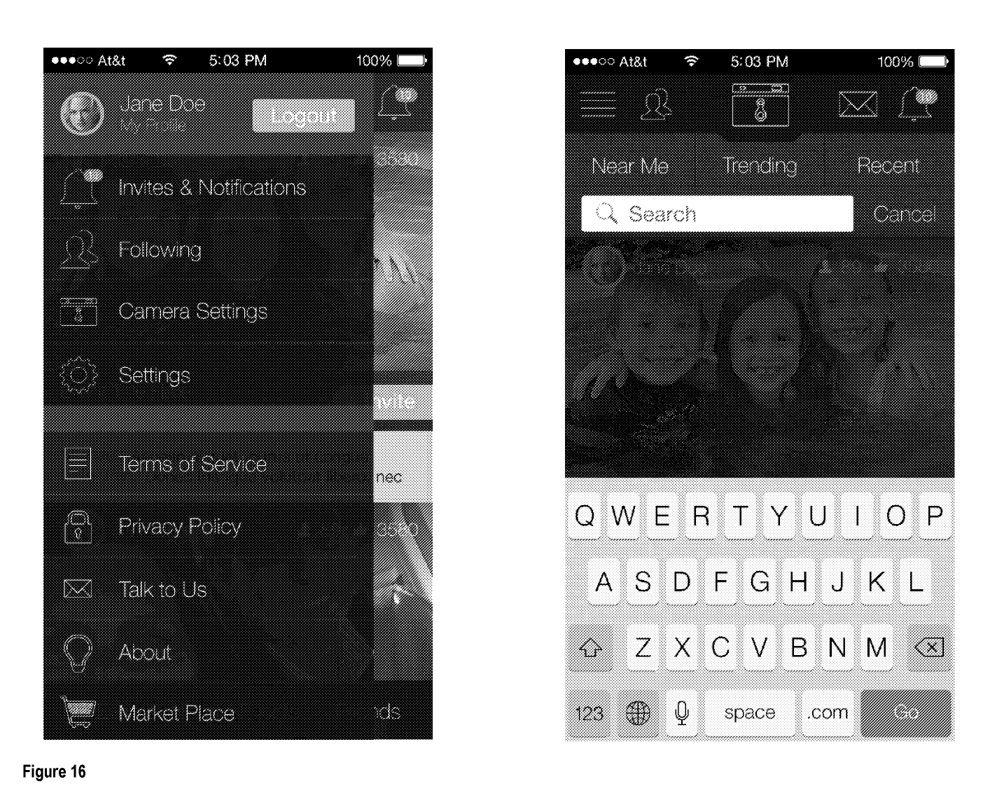

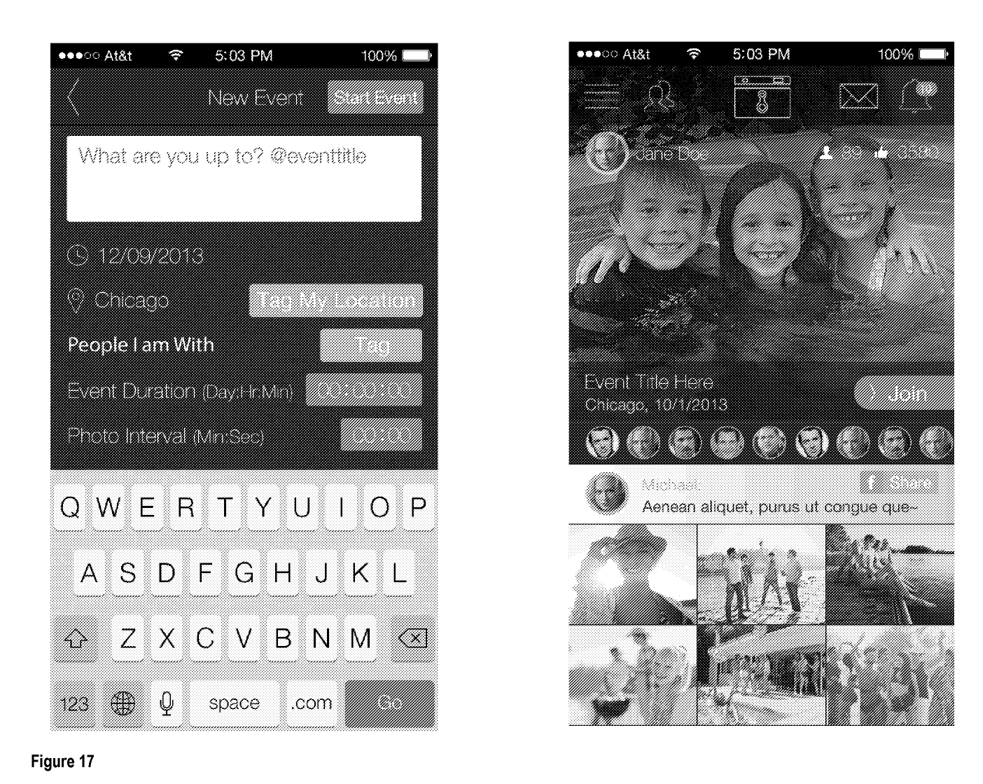

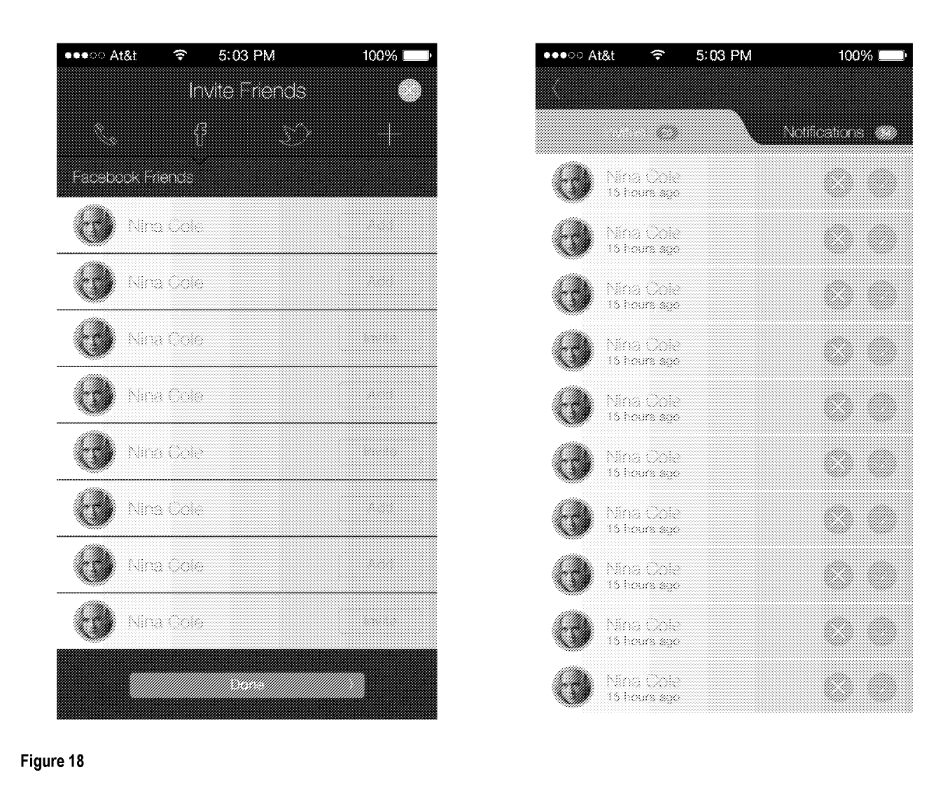

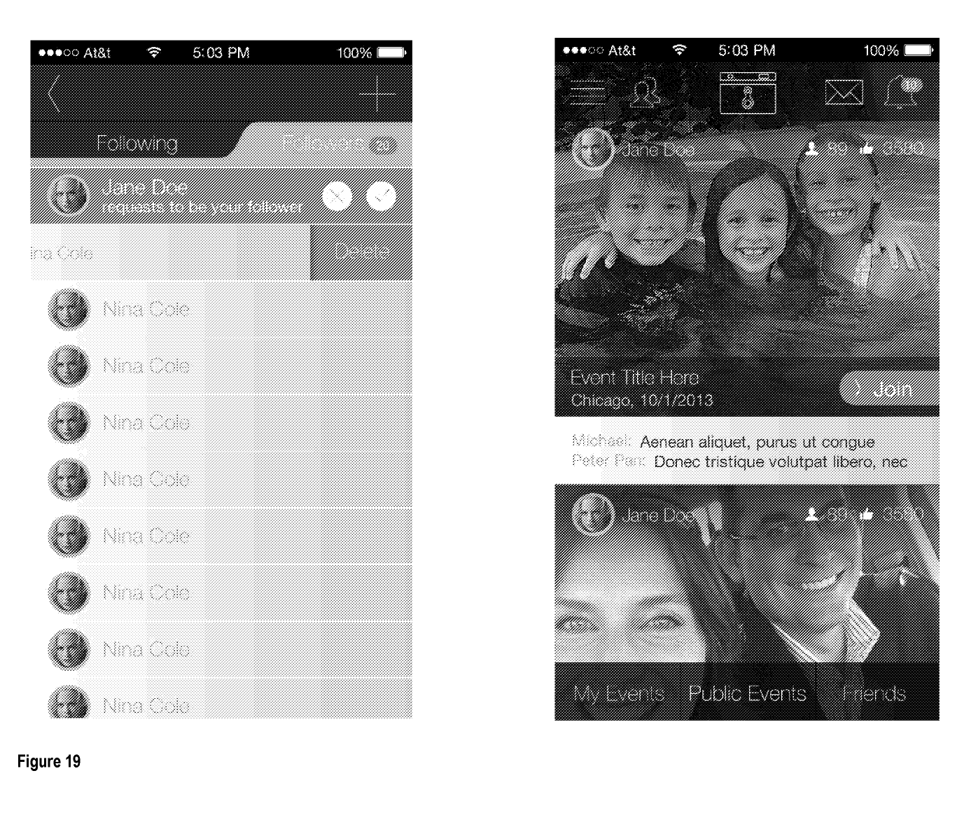

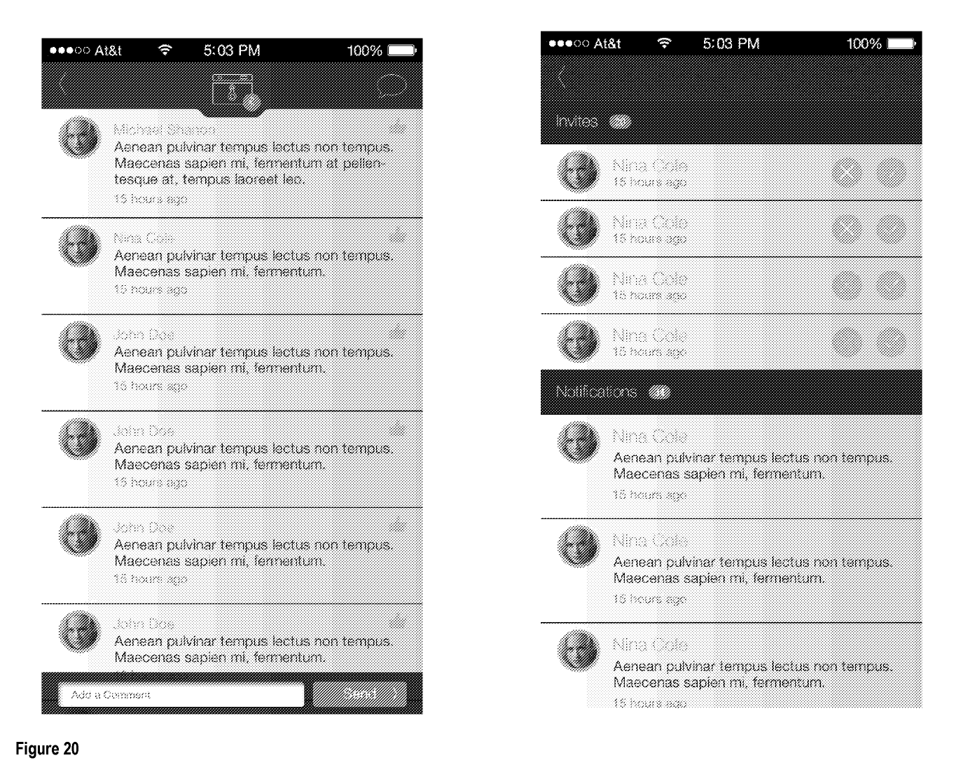

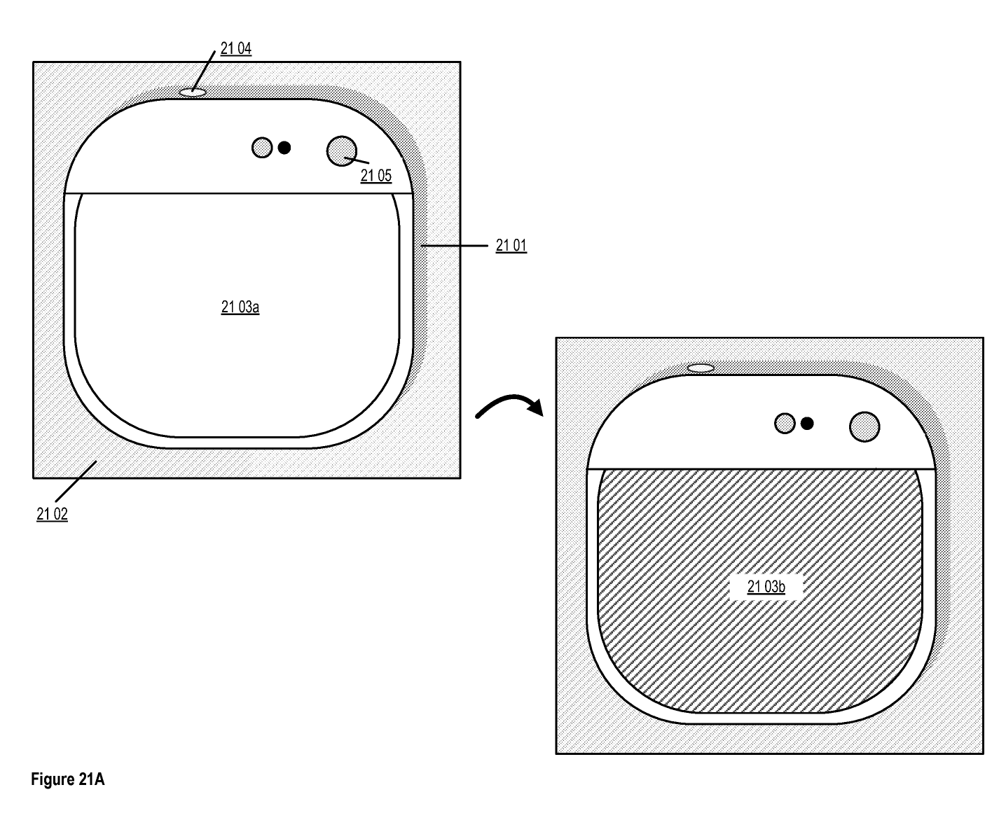

FIGS. 11-20 show example CMN user interfaces, in one implementation of the CMN operation.

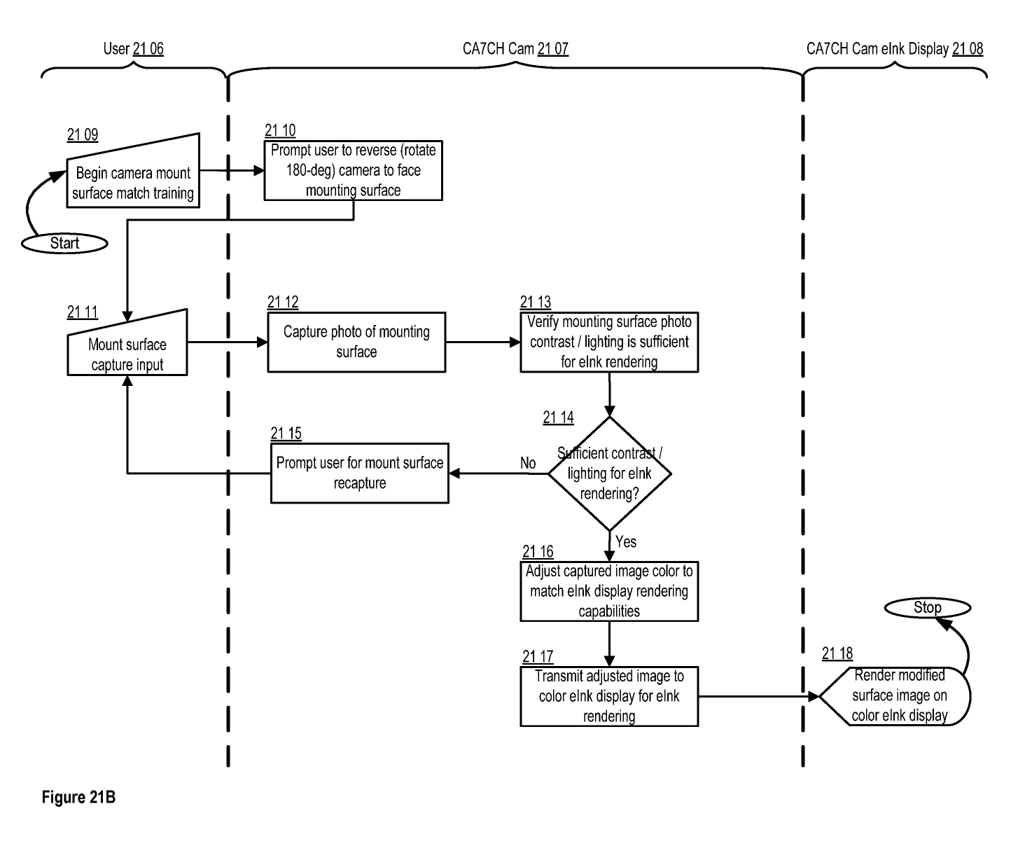

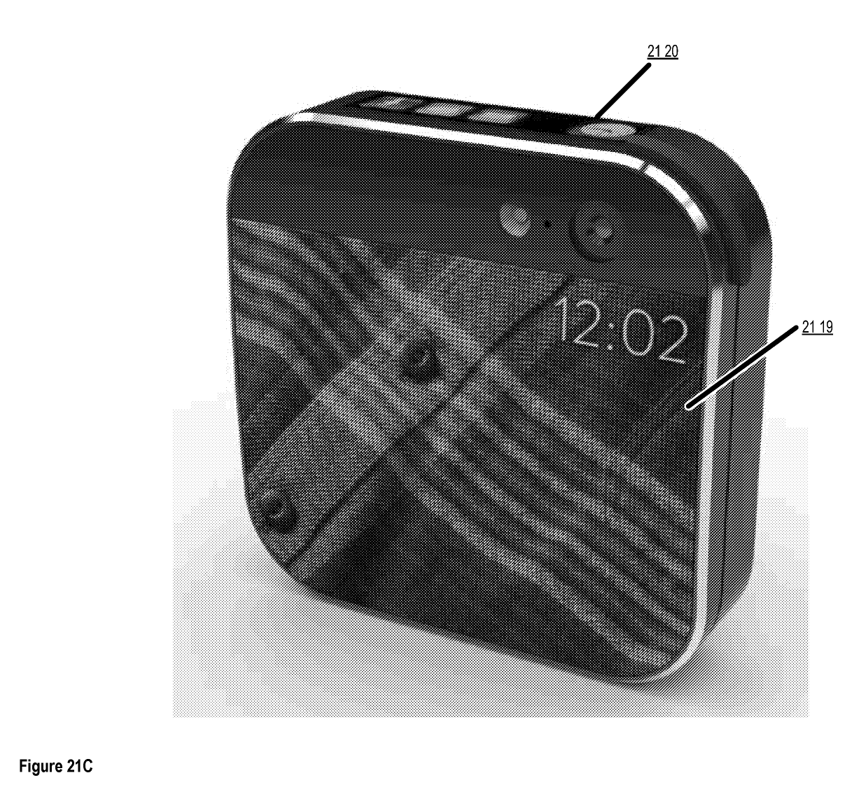

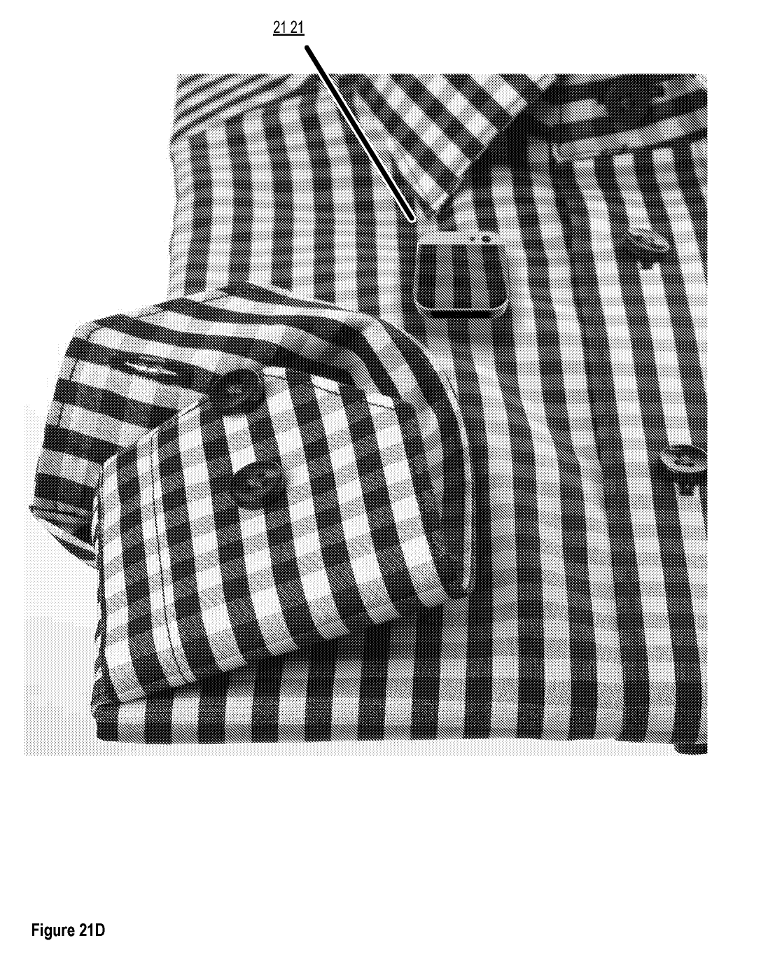

FIG. 21A shows example aspects of a CMN wearable photo capture device incorporating eInk surface matching, in one implementation of the CMN operation. In one embodiment, a wearable photo capture device 2101 may be mounted on a surface 2102 such as a shirt, wall, etc. The mounting may be accomplished via any of the mounting mechanisms or using any of the mounting adapters discussed herein and particularly with respect to FIG. 1A.

In one embodiment, the wearable photo capture device may incorporate a front-facing color eInk display 2103a, such as for example a display incorporating EInk Corporation's Triton reflective electrophoretic imaging film. The eInk display may be incorporated into the device design such that its imaging surface covers a portion of the wearable photo capture device otherwise viewable to others. The display may, as described below, thereafter be configured to present an image that substantially corresponds to the surface on which the wearable photo capture device is mounted (e.g., the surface covered by the device when mounted). By doing so, the eInk display may help the wearable photo capture device blend into the background visual environment while otherwise allowing the device to continue normal operation. Although discussed herein with respect to eInk displays, it is to be understood that the techniques described with respect to eInk are equally applicable to other display technologies. For example, other display technologies may be used in place of the described eInk displays if the energy consumption profile of those displays is suitable for low power continuous image display.

In one embodiment, an interface button 2104 may be utilized to initiate a surface matching routine, further described with respect to FIG. 21B, whereby the device is rotated by the user such that the camera 2105 faces the surface on which the device will be mounted. The camera may then capture a photo of the mounting surface. After the captured image is processed to be suitable for color eInk rendering, such as by limiting the dynamic color range of the image to comport with the eInk display's color rendering spectrum capabilities, the eInk display may be reset (flashed, loaded) and thereafter display a color pattern that corresponds to the mounting surface photographed, e.g., 2103b. Beneficially, once an image is loaded onto the eInk display the display does not require continual power to maintain the image and therefore such a configuration has particular benefits for the wearable photo capture device's operation.

FIG. 21B shows an example logic flow for eInk surface matching in a CMN wearable photo capture device, in one implementation of the CMN operation. In one embodiment, user 2106 may initiate a camera mount surface match training procedure, e.g., 2109. The surface match training procedure facilitates the capture, using the integrated wearable photo capture device's camera or another camera device in communication with the device, of the surface on which the wearable device is to be mounted. For example, if a user were to desire to mount the wearable photo capture device on their shirt, the mount surface to match would be the fabric color and pattern of the user's shirt.

In one embodiment, the wearable photo capture device 2107 may prompt the user to rotate the device 180-degrees such that the normally outward facing camera faces inward to the mount surface, e.g., 2110. Once oriented to the surface, the user may initiate a second input, e.g., mount surface capture input 2111, to instruct the camera to take a photo of the mount surface, e.g., 2112. In other implementations, the wearable photo capture device may itself determine the moment of mount surface capture. For example, since mount surfaces often contain distinct repeating patterns or areas of constant color (such as a shirt pattern), the wearable photo capture device could capture the mount surface upon detecting such a pattern in front of the camera during the camera mount surface training procedure.

In one embodiment, the wearable photo capture device may analyze the resulting surface image to determine if it is suitable for color eInk display. Some eInk displays, for example, may have limited contrast capabilities and as such may have difficulty displaying mount surface representations that lack sufficient contrast because of inadequate lighting during image capture. If the captured image is not suitable for rendering, e.g., 2114, the user may be prompted to recapture the mount surface, e.g., 2115. If the captured image is suitable for eInk rendering, e.g., 2114, the image may nevertheless be optimized to match a more limited rendering capability profile, e.g., 2116. For example, some eInk displays may lack the ability to display very fine grained textures due to their relatively low resolution. In such a case, the wearable photo capture device may process the image to determine a dominant color and substitute the detailed texture image initially captured for one containing only that color. Although such a configuration would not allow the wearable photo capture device to completely blend into the surrounding visual environment, the matching color capability may itself be desirable even when the underlying mount surface pattern can not be displayed. Once the captured image has been sufficiently optimized for rendering, the device may signal the eInk display 2108 to reset its display and display the optimized image, e.g., 2117. The eInk display may thereafter display the optimized image such that the user can mount the wearable photo capture device and the eInk display rendered image is displayed in a manner that allows the device to better blend into its visual surroundings, e.g., 2118.

FIGS. 21C-D show example aspects of a CMN wearable photo capture device incorporating eInk surface matching, in one implementation of the CMN operation. In one embodiment, an eInk display may be utilized to display a pattern matching the background on which the wearable photo capture device is mounted, e.g., 2119. An interface 2120 may allow the wearable photo capture device user to initiate a capture routine to set the eInk display to show the current mounting surface. In one embodiment, the resulting display of the mounting surface on the eInk display may allow the mounted wearable photo capture device to better blend into the visual environmental surroundings, e.g., 2121.

### Social Network Framework

In some implementations, the mobile application may facilitate a social network (SN) framework. The SN can be media focused and can allow users to collaborate and/or share media they have captured. In some implementations, all media shared on the SN is captured in substantially real-time. The SN may not allow access to a mobile device's camera, thus ensuring that content captured by the wearable photo capture device is being uploaded and shared. The SN can allow users to define Events (e.g., media albums specific to a particular location, real-life event, and/or particular users). Events can be public or private Events. Public Events can allow any user within a pre-determined geolocation range of the event creation location to join the Event. Users who join the Event can capture new media and can upload said media to the Event, e.g., via their wearable photo capture device and/or their mobile device. In some implementations, users can have user quotas (e.g., a maximum amount of media the user can store on the CMN), and content added to events may not count towards the user's quota. The user may still be able to view the Event media, e.g., via a user timeline and/or Event library. Private Events may only allow invited users to contribute new media to the event. Just as with the Public Event, content submitted to the Event may not count towards a user's quota, though it can still be accessible to the user via numerous interfaces.

Access to other users' entries submitted to the Event can be restricted. For example, a user may need to obtain access to an Event in order to access Event entries (e.g., the user may need to be a part of the Event, may need to be following the user who created the Event, may need to be tagged in content within the Event, and/or may access a Public Event). Other access schemes include allowing users to subscribe to an Event (e.g., for a pre-determined amount of time) via payment of a subscription fee, and/or providing particular users media submission privileges, without allowing said users to view other media submitted to the Event.

In some implementations, content consumed by users in the SN portion of the mobile application can be live media being streamed by a user and available for substantially real-time streaming, and/or point it time media which has already been captured, and which is not uploaded and shared substantially in real time. Users can also share media with other users who choose to follow them (e.g., who choose to receive updates and/or other notifications of the user's activity), through the mobile application. Users can also share media through other social network and/or web applications, including but not limited to Facebook, Twitter, YouTube, Vine, and/or other such services. Shared Events can be updated by users via providing additional media to the Event, e.g., until the Event has elapsed (e.g., after a pre-determined Event duration period). In one embodiment, each user may retain the rights to their images. All users may see the Event through the perspective of every other user.

Users within the SN can have a variety of functions. Users can be individuals and/or business entities, and can have a public and/or private page. Users can also have a social graph, e.g., which can include the user's friends, followers, and the users that the user is following on the SN. Friends can be tagged in media, and/or can be invited to contribute media (e.g., within public and/or private Events). Friends (e.g., reciprocal connections between users, which can be approved and/or auto-allowed) can share media feeds (e.g., substantially in real time). Users can also follow and/or be followed by users (e.g., without a reciprocal connection with the other user), such that the user can receive and/or send media feeds to users who the user has followed and/or who have followed the user, respectively. If a user follows another user, the other user may not automatically receive media feeds from the user, and/or vice-versa.

In addition to following users, users can follow, rate, and/or otherwise interact with media Events. For example, a user can “like” an Event, which can allow the user to favorite the Event, and/or can allow the user to express their opinion about the Event. Liked events may be forwarded to friends and/or followers' media feeds, such that friends and/or followers can be apprised of media the user is viewing. The user can also share public Events and/or media that he likes by sharing the media and/or Events on other social media networks (e.g., Facebook, Twitter, Vine, and/or the like).

When a user first signs up for a SN account and/or profile, the user may provide identification information (e.g., an email address, password, username, an external social media profile (e.g., a Facebook profile), a location (e.g., a city and/or state), a gender, a birthday, the user type (e.g., a person and/or a business entity), and/or other such information. The user may also provide access to his wearable photo capture device (and/or can be prompted to purchase a wearable photo capture device if the user does not already have a wearable photo capture device), such that the SN can import media and/or other settings from the wearable photo capture device. The user may also be prompted by the wearable photo capture device to define a number of wearable photo capture device settings, and/or the like, in order to enable the connection. For example, the user may be asked to specify whether the wearable photo capture device will connect to the SN via a Bluetooth connection with a mobile device, a Wi-Fi connection with the mobile device, and/or via other means. The user can also specify auto-connect settings, identifiers in order to distinguish multiple wearable photo capture devices being connected to the SN apart, and/or the like.

Once the user has a profile connected to his wearable photo capture device, the user can create Events (e.g., by creating Event data structures and linking media captured by his wearable photo capture device to the Event), can invite and/or send media notifications to users outside the SN, share media with users within the SN, friend and/or follow other users, and/or edit his profile page and/or uploaded media files. Users can also view a number of shortcuts to features including but not limited to a friends/following media feed (e.g., a media feed from friends and/or users the user is following), the user's profile page, public events, notifications and/or invitations, settings, messages, friends, a Find Friends feature, an Add/Remove Friends feature, an Invite Friends feature, and/or a Blocking Users and/or Media feature (e.g., to block users from connecting with the user, to block certain media from being shown in the user's media friends/followers feed, and/or the like).

The user can also access a number of settings, including but not limited to password select/reset & primary email settings, account deletion settings, privacy settings (e.g., who can see posts, who can see the user's profile, who can see the user's personal information), friend request settings (e.g., who can send friend requests, and/or whether requests are manually approved by the user or auto-approved), Event settings (e.g., who can join public Events, e.g., any users near-by, any users, only friends, friends of friends, and/or the like), push notification settings, general notification settings (e.g., sound and/or vibration notification settings, and/or the like), message settings, settings for commenting on user-created events, settings for reminders about being in an active Event when capturing media, social media (e.g., Facebook, Twitter, and/or similar social media networks) integration settings, content filter settings, (e.g., safe content settings, auto-approval of media from particular users, and/or the like), auto-posting and/or auto-uploading settings, media correction settings, photo interval settings, and/or other such wearable photo capture device media capture settings, image storing settings, and/or payment settings (e.g., whether to use a credit card, PayPal, and/or similar payment methods, a default payment method, and/or the like).

The SN can (e.g., for copyright and/or like purposes) ensure that content uploaded to the SN be original media captured by a wearable photo capture device (e.g., rather than content retrieved from a mobile device's media library). To provide media to the SN, the user may define posts (e.g., an individual data structure for a single media file) and/or Events, and may upload the media content in connection with the post and/or Event being created. Additionally, users can choose to automatically define posts and/or Events to upload media to as the user's wearable photo capture device captures new media data. For example, a user can select a particular Event to automatically upload media to, e.g., until the user removes the setting, and/or based on criteria such as the time and/or geo-location at which the media was captured. The user can specify an Event duration, an Event geolocation, a privacy setting (e.g., whether the Event is public or private), a spatial limitation on who may join and/or contribute to the Event, if the user marks the event as public, and/or a limitation on who may join and/or contribute to the Event, irrespective of geolocation factors, if the event is marked as private. Users can then share and/or invite others to view their uploaded media. Users can also join public Events and contribute their own original content to the Event. Users can be notified by the SN when they are within a geographical proximity to a public Event to which they can contribute. The SN can automatically monitor content to make sure it is appropriate for the Event (e.g., based on the time it was captured, the location where it was captured, and/or the like). The SN may also remind users when they have specified settings to upload content to an Event, such that the users can make sure they upload relevant content to the Event.

If a user receives an invitation to an Event, the user can accept and/or decline the invitation. If the user chooses to accept the invitation, the user can be added to the Event, and can specify media content to share with the Event, and/or can provide new content to provide to the Event substantially in real-time. The user can also add comments and/or ratings to other media content in the Event, and/or can send friend requests to other users. Users can also choose other users within the Event to follow. When the user views content in the Event, the user may be directed to an Event View or Album View mode. The first segment of the Event may include information about the Event, including a description, a location, and the duration of the Event. The Event View can then show at least one media content file posted to the Event, as well as recent and/or most-liked comments posted to the event in general, and/or to particular media files within the Event. In some implementations, thumbnails of media content can be stacked to indicate that there are more media files in the Event than clearly shown on the first page; the user can select the stack to view all of the media files included in the Event. In other implementations, a full screen thumbnail view of all the media files (e.g., shown in a grid layout and/or the like) within the event may be provided, and the user may be able to scroll through the thumbnails to select media files for further viewing. scrolling down. The thumbnails may be sorted by time, by username, and/or by a number of criteria that the user can select. Clicking a thumbnail may lead the user to a screen with media file and a profile image and/or username of the user who contributed the media file.

Users can choose to leave the Event and/or cancel contributions to the Event, e.g., if they no longer wish to contribute to the Event, and/or if they want to remove their content from the Event. Users can also search for media, users, and/or Events to view and/or follow. Users can search using keywords, using hash-tags, usernames, locations, and/or the like.

Users can also use the SN to communicate with other users. For example, a user can send messages to other users, can comment on content uploaded to the SN by other users, or in response to other comments provided to other users.

### Additional Embodiments

In some implementations, a CMN can facilitate various embodiments and functionality (including features in additon to those described above). For example, a wearable photo capture device can be operated by a user by pushing buttons on the wearable photo capture device (and/or by pushing a single multi-functioned button which can be programmed by the user on a mobile application). The user can also operate the wearable photo capture device by using a view-finder button on the mobile application, e.g., when the wearable photo capture device and/or the mobile device running the mobile application are connected (e.g., via Bluetooth, Wi-Fi, cellular networks, and/or similar communication modes). The user can also define wearable photo capture device Events during which the wearable photo capture device can automatically capture media (e.g., images, bursts of images, short videos, continuous video, and/or continuous audio). Events can last for a user-determined period of time, and/or for user-defined intervals of time. Additionally, the wearable photo capture device can use various sensors (e.g., including but not limited to sound, motion, acceleration, gyroscope, proximity, light, microphone, and/or temperature sensors) to trigger functionality of the wearable photo capture device.

For example, once a specified sensor has obtained specified readings, and/or once a sensor threshold has been reached, the wearable photo capture device can start to capture media, send notifications to the mobile application, and/or the like. For example, if the motion, acceleration, and/or gyroscope sensors indicate that movement of the wearable photo capture device is below a threshold (e.g., that the wearable photo capture device is not moving significantly), and/or if the sensors indicate that the wearable photo capture device is in the middle of a stride and/or some other movement, the wearable photo capture device can start capturing media. If, on the other hand, the sensors indicate that movement has increased, and/or that the wearable photo capture device is in the middle of a movement, the wearable photo capture device may delay capturing media until the sensors indicate that the movement has slowed, and/or the like. In another implementation, the wearable photo capture device can determine a media capture state (e.g., a positive “capture media” state and/or a negative “delay capturing media” state) based on the sensor data. For example, if sensor data from a light sensor indicates that the scene is dark, the wearable photo capture device can determine that a media capture state is “delay capturing media,” and can decide to delay capturing media. Once the light sensor indicates that the scene is brighter and/or amenable to capturing media requiring a specified threshold of light, the wearable photo capture device can determine that the media capture state has changed to “capture media,” and can begin to capture media again. Similarly, if the wearable photo capture device is moving too quickly and/or frequently, the media capture state can be set to “delay capturing media” until the wearable photo capture device has stopped moving, appears to be in the middle of a movement, and/or the like. In some implementations different sensors can provide their own media capture states. Certain sensor data may take priority over other data; e.g., if the light sensor indicates a “capture media” media capture state, the wearable photo capture device may capture media even if movement sensors provide a media capture state of “delay capturing media.” In other implementations, if any media capture states are “delay capturing media” from any of the sensors, the wearable photo capture device can delay capturing media until all the sensors have a media capture state of “capture media.”

The wearable photo capture device can store media and/or other data in multiple ways. For example, the wearable photo capture device can stream media to the wearable photo capture device's view finder (e.g., on a mobile device) in substantially real-time, e.g., without use of a buffer. Such media may be limited, e.g., may not contain audio, may only include video media and/or image media as bandwidth and/or other network restrictions allow, and/or similar restrictions. The mobile device may store the media in memory to provide the media in its viewfinder interface. The wearable photo capture device can also store media in Flash memory, and/or within a cloud and/or similar server (e.g., such as the CMN). The wearable photo capture device can instruct the mobile device to retrieve the media on the wearable photo capture device, such that the mobile device stores the media in its own memory, e.g., when the wearable photo capture device is connected to the mobile device. The wearable photo capture device can capture media and store the media locally to the wearable photo capture device Flash memory, e.g., in 10-second and/or similar period HTTP formatted buffers, and the wearable photo capture device can manage the index file. The wearable photo capture device can then provide the media to the mobile device for streaming (in substantially real time) or storage, when the wearable photo capture device is connected to the mobile device. In some implementations, the wearable photo capture device's memory can be cleared as soon as media is provided to the mobile device. The wearable photo capture device can also send media to the CMN when the wearable photo capture device is connected to the CMN, e.g., via Wi-Fi. The wearable photo capture device can be configured to store the media locally, e.g., until the media can be provided to the CMN. The user can specify to which locations and/or devices the wearable photo capture device can send captured media, and/or whether the CMN, and/or the mobile device, can forward media to each other, and/or to other devices. The mobile device can also obtain thumbnails and/or similar images for media from the CMN, e.g., for display within the mobile application.

The wearable photo capture device can use a media processing element to use a variety of sensors to meta-tag (e.g., add metadata to) captured media. Such sensors can include, but are not limited to, vibration sensors, acceleration sensors, orientation (gyroscope) sensors, temperature sensors, proximity sensors, and/or other such sensors. In some implementations, the media processing element can use the sensor data and/or other data to affect how the media file is tagged, processed, and/or captured by the wearable photo capture device. For example, global positioning system (GPS) location data can also be appended to the media by the mobile application, e.g., when the media is downloaded, based on time synchronization with the wearable photo capture device and/or other criteria. Other user-related data (e.g., such as the user's username, mobile device information, user identifier, and/or the like) can also be appended to media files by the mobile application. An image recognition module, e.g., implemented by the CMN and/or the application, can employ image recognition and analysis to include more metadata within a media file based on content (e.g. to add metadata to include keywords associated with locations, buildings, persons, animals, seasons, weather, and/or other information which can be extracted and/or inferred from the media). In some implementations, voice tags a user creates for the media file can be transcribed into text by the mobile application and appended to the media as metadata. The CMN can also receive voice tags and media files, and can meta-tag the media file with the voice tag.

In some implementations, time-based media capture can be performed through a sliding window which can correlate capturing the media to sensor data such as acceleration and/or vibration data. Meta-tagging media with sensor data can help the CMN process media, e.g., to improve vibration stabilization performed by the CMN, to improve media filters, to improve auto-correction of media files, and/or other such processing mechanisms. The CMN can also automatically delete images which the CMN is unable to correct (e.g., media which is too blurry and/or over-exposed, and/or the like).

In some implementations, the wearable photo capture device can connect to multiple mobile devices (e.g., wherein the wearable photo capture device is functioning as soft access point) or a mobile device can connect to multiple wearable photo capture devices (e.g., wherein the mobile device is functioning as soft access point). In some implementations, the mobile application manages all of the wearable photo capture device settings and user interface settings. A mobile device- wearable photo capture device interface can be implemented wirelessly, whether performed locally over, e.g., Bluetooth, or remotely, e.g., over Internet Protocol (IP) with cloud negotiation.

In some implementations, the wearable photo capture device can have a magnetic rear plate with a form factor design to account for general purpose attachment. Essentially, the attachment action may be a snapping of the accessory and the camera together. This form factor can have embedded notches to prevent sliding and rotation. Attachment accessories include but are not limited to Wristband, Necklace or chain, Headband, Lapel pin, Pocket clip, Helmet bracket, Lanyard, and/or similar attachments.

In some implementations, substantially real-time transfer may be facilitated if media is transferred from the wearable photo capture device to a mobile phone, tablet-type device and/or the like. The wearable photo capture device may have the ability to capture high resolution images and video. The mobile application may need only a small fraction of the image resolution for user interaction and image selection and socialization. The same may be true for substantially real-time video streaming. A lower resolution video stream can be used to provide capabilities like a view finder. The optimization used to transfer the lower resolution video stream may be a combination of sub-sampling of the media for preparation to transfer over the wireless link, while maintaining the full resolution stored locally in memory for eventual transfer across the wireless link.

In one embodiment, on the front of the wearable photo capture device, a notched out channel may allow lens accessories to be attached externally. The attachment may allow for lenses to be rotated and locked into place. This concept expands the wearable photo capture device's ability to capture images with various types of lenses including but not limited to: a macro lens, wide angle lenses, and/or Telephoto lenses. In one embodiment, the on-board optics of the wearable photo capture device may have a fixed field of view, so this capability enhance the wearable photo capture device's capabilities and offers more options for 3rd party accessory involvement.

In one embodiment, the circuit used for induction charging may conform to the newly created standard for these types of devices. In one embodiment the wearable photo capture device may be a wearable device that offers induction based charging.

In one embodiment, the handshake protocol between the wearable photo capture device and the mobile application may allow the ability to communicate the wireless capabilities to each other. For instance, the mobile device may communicate that it has Wi-Fi capability, but not Wi-Fi Direct, and this may prompt the wearable photo capture device to automatically employ a secondary Wi-Fi based method for media transfer. In one embodiment the wearable photo capture device may facilitate remote viewfinder capability in a constant connected mode.

In one embodiment the feeds from several wearable photo capture devices at the same event may be employed to create a 3D image from multiple vantage points. Processing may take place after the fact and in the CMN. In one embodiment, a person may mount or more wearable photo capture devices (e.g., front and back), and can use the data from both wearable photo capture devices to create a multidimensional space by overlaying images for depth, 3D effects. In some implementations, multiple wearable photo capture devices can be used by more than people at the same time. Collate images together may be created using the knowledge of which direction the wearable photo capture devices are facing. In one embodiment the storage may be divided between the wearable photo capture device and mobile device as a temporary storage space, while CMN storage may be the final storage location. In one embodiment a wearable photo capture device-to-CMN, group-storage model may be adopted.

In one embodiment the wearable photo capture device's accelerometer may be employed to time photo capture based on minimal movement/vibration. In one embodiment the image resolution and compression may be combined to optimize wearable photo capture device-to-application throughput. In one embodiment, the wearable photo capture device facilitates after the fact image and video stabilization in the CMN. In one embodiment the wearable photo capture device may employ algorithms for stabilization and/or the like. It may use the data to determine wearable photo capture device orientation for 3D images or may capture images over time, e.g., in the form of a mosaic, and/or may use time lapse imaging. In one embodiment audio sensors may be wirelessly connected or CMN-enabled that may send notifications to the CMN that are processed and sent to a mobile device. Example embodiments are a baby monitor application and how it may interpret audio signals to notify users that something is happening with a baby. In one embodiment, there may be a process to enable Bluetooth. Once bonded, one or multiple wearable photo capture devices may present the image they are capturing in small thumbnails in the application. (in some implementations, Bluetooth may accommodate multiple bonded devices.) The user then may have the option to select a wearable photo capture device based in the image they see, rather than based on a name or ID number.

In one embodiment a CMN-based application may be employed to show geo-spatial data location of wearable photo capture devices around the globe. In one embodiment the application can allow users to ping other users that are located nearby for social gatherings, meet-ups, event joins, etc. In one embodiment the application may leverage the API to communicate with mobile devices and/or wearable photo capture device. Connections can be local or over a Wi-Fi network and/or another connection to the internet. The mobile application can facilitate access to multiple feeds for the user to select, stream, and/or capture. This embodiment may also include sensor data combining as well.

In one embodiment the radio beacons may trigger the wearable photo capture device to take an image and mark it with the beacon location to build density apps of device locations within buildings. In one embodiment the wearable photo capture device may generate optical markers (e.g., pattern or color based) available to advertisers, gamers, and/or other user groups for use in interactive applications. Markers may be detected via visual computing algorithms to provide a mechanism for user feedback (e.g., ads, information, graphics, and/or game notes) or for stitching images together to present a larger visual canvas. In one embodiment a wearable photo capture device application programming interface (API) may be employed as an application itself, to facilitate the use of various cameras and/or wearable devices as wearable photo capture devices. In one embodiment, all media may be meta-tagged. An anonymous and unique identifier may be attached to each media file to track owners of the media, e.g., to compensate media owners, to provide them with data about their media content, and/or for other such actions. In one embodiment a mechanism to automatically tag the images from individual users may be employed. In one embodiment unique identifiers may be added to each image (e.g., using a universally unique identifier (UUID) and/or MD5 hash codes). In one embodiment, the UUID may in effect globally uniquely mark the media file so that the media file can be identified as coming from a specific user, at a specific location, and/or from a specific wearable photo capture device. This marking approach may be used with the above marketplace to manage copyright. The method used to mark the media files may also be used to detect tampering. In one embodiment media files can be stitched together based on the geo- location of the captured media files, the direction the wearable photo capture device was facing when the media files were captured (e.g., based on an onboard sensor), and the time the media files were captured. These media files may then be stitched into a single common time-lapsed stream to the single stream can then be used for surveillance, traffic monitoring, density applications, and/or a variety of other related functions. In one embodiment an application can leverage the relative pixel size of detectable objects within a media file to determine the distance that the objects are from the location that the media file was captured.

The CMN can also facilitate logging of data related to a user, his wearable photo capture device, to the SN, and/or to the application. For example, the CMN can log a user's frequency of use, a daily application use duration, an individual page visit duration, a number of media files captured and/or uploaded per day, hour, and/or minute (e.g., per user, or by all users), a frequency of user comments being posted, a frequency of video files, image files, and/or other particular media files being uploaded, statistics on most-used features, a database size and/or performance readings (e.g., amount of time needed to respond to server requests and/or input/output (I/O) ii readings), time required for packets to be transmitted using the API as described above, a size of packets transferred via the API, and/or a number and/or frequency at which the API is used to facilitate various functions within the CMN. Logs can be analyzed to determine how users use the wearable photo capture device, the SN, and/or the application most, and/or to determine where system delays may be originating.

In some implementations, the CMN can also facilitate advertising. For example, advertisements can be injected into media feeds and/or Events shown within the SN, and can be selected at random, and/or based on textal analysis of a user's profile, analysis of the user's location, and/or analysis of the user's media content. Particular sponsors can pay a fee to select particular Events to target their advertisements towards. Users may be able to filter advertisements (e.g., to prevent offensive content from being provided to the user), and/or can pay subscription fees to completely remove advertisements from their media feeds.

### Additional Functional Specifications

The wearable photo capture device can include software and/or hardware configured to facilitate any of the following functions: commanding the wearable photo capture device to take photos, commanding the wearable photo capture device to focus, detecting lighting levels and comparing the levels to established thresholds, controlling flash and/or status light-emitting diode (LED) lights, controlling a speaker on the wearable photo capture device, commanding the wearable photo capture device to shoot video, and/or storing captured media in local flash memory. The wearable photo capture device can also accept commands from an application running on a mobile device, including but not limited to down-sampling media files to reduce the size of the media file in preparation for transfer to the mobile phone, sending media to a Wi-Fi Direct-connected mobile device, and/or sending media to a mobile device over a standard Wi-Fi network.

The wearable photo capture device can also facilitate processing input from a button on the wearable photo capture device to command the wearable photo capture device to capture media content, as well as a number of other functions (e.g., stopping capture of a stream of media, deleting media, and/or the like) based on a number and speed of a button press, turning the wearable photo capture device on and/or off, controlling input from a microphone element on the wearable photo capture device and recording audio, and/or interpreting input from various sensors (e.g., accelerometer, magnetometer, gyroscope, and/or the like) to determine a movement status of the device.

In some implementations, an API may be employed for the mobile phone application and camera to interface through. The API can, for example, drive the entire messaging chain between the two applications. The API interface may accommodate the following: wearable photo capture device discovery, network connection negotiation, network connection credentials configuration, wearable photo capture device capture mode configuration, substantially instantaneous wearable photo capture device capture (e.g., capturing media on demand), viewfinder mode instantiation, battery life statistics, signal-level indicator for both Bluetooth and Wi-Fi, wearable photo capture device configuration query to synchronize the application described above with wearable photo capture device, remote power off commands, and/or the like.

In some implementations, an application running on a mobile device may have a user function to enable discovery of a wearable photo capture device. The discovery mechanism may be Bluetooth. Through the discovery process, a mobile device may communicate its WiFi capabilities and whether such capabilities include Wi-Fi Direct. If Wi-Fi Direct is available, then a Wi-Fi Direct connection may be made directly between the mobile device and the wearable photo capture device. If it is not available and both devices are within a known Wi-Fi network, then additional credential information may be passed to the wearable photo capture device so it can connect to the Wi-Fi network. When either device loses its WiFi connection, the application may run a discovery mode automatically to re-establish communication with the wearable photo capture device.

In some implementations, the wearable photo capture device may detect movement to augment when media is being captured, in an attempt to further stabilize the wearable photo capture device for a better shot. For example, if movement of the wearable photo capture device may cause media to be blurry, the sensors can be used in order to determine a time at which to capture the media such that the movement is less likely to affect the sharpness of the media file. Alternatively, if the wearable photo capture device can predict the type of movement being made, e.g., based on the sensor data and analyzing the sensor data to determine how the wearable photo capture device is moving, the wearable photo capture device may use the sensor data to automatically correct the media being captured (e.g., automatically correct a blurry photo, and/or the like) based on the movement knowledge the wearable photo capture device derives from the sensor data. Additionally, the wearable photo capture device can automatically fix media by brightening the media file, e.g., when a light sensor indicates that the environment has low light, and/or the like. Additionally, the wearable photo capture device may detect, using sensor data, light saturation, and/or when the wearable photo capture device is face down on a horizontal surface. The wearable photo capture device may also accept verbal commands to perform certain functions (e.g., to capture media, to stop capturing media, to send media to the CMN and/or the mobile device, and/or the like.

### CMN Controller

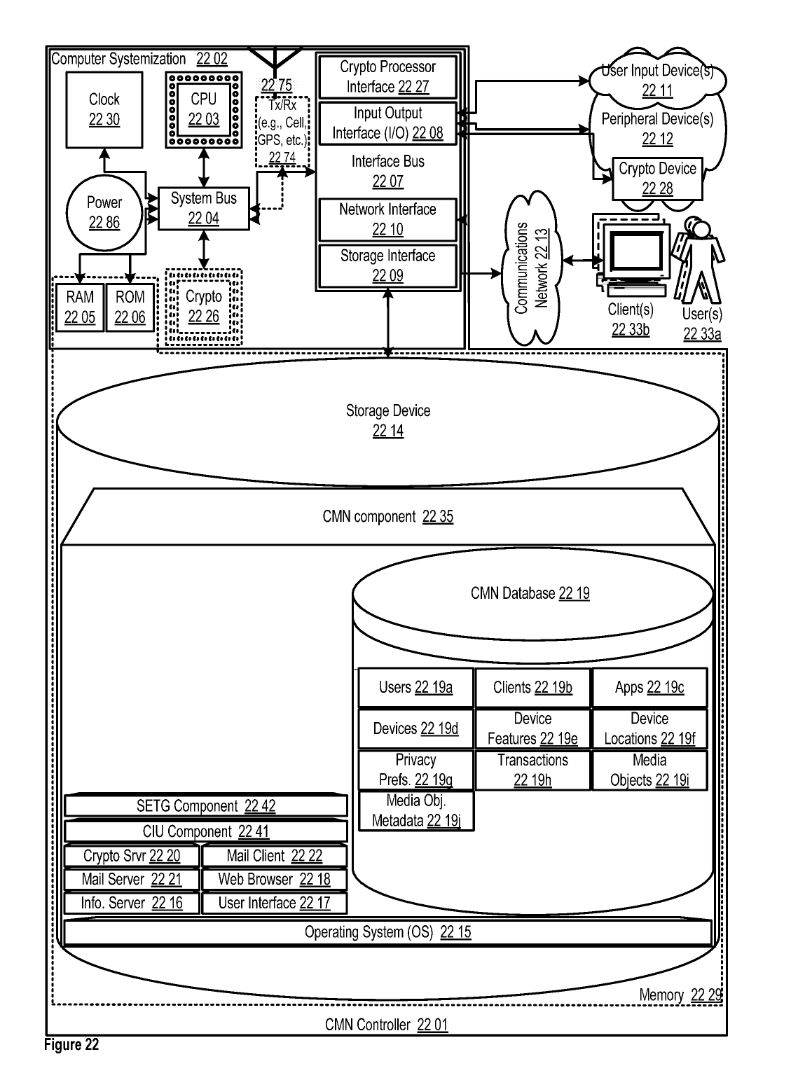

FIG. 22 shows a block diagram illustrating embodiments of a CMN controller. In this embodiment, the CMN controller 2201 may serve to aggregate, process, store, search, serve, identify, instruct, generate, match, and/or facilitate interactions with a computer through various technologies, and/or other related data.

Typically, users, which may be people and/or other systems, may engage information technology systems (e.g., computers) to facilitate information processing. In turn, computers employ processors to process information; such processors 2203 may be referred to as central processing units (CPU). One form of processor is referred to as a microprocessor. CPUs use communicative circuits to pass binary encoded signals acting as instructions to enable various operations. These instructions may be operational and/or data instructions containing and/or referencing other instructions and data in various processor accessible and operable areas of memory 2229 (e.g., registers, cache memory, random access memory, etc.). Such communicative instructions may be stored and/or transmitted in batches (e.g., batches of instructions) as programs and/or data components to facilitate desired operations. These stored instruction codes, e.g., programs, may engage the CPU circuit components and other motherboard and/or system components to perform desired operations. One type of program is a computer operating system, which, may be executed by CPU on a computer; the operating system enables and facilitates users to access and operate computer information technology and resources. Some resources that may be employed in information technology systems include: input and output mechanisms through which data may pass into and out of a computer; memory storage into which data may be saved; and processors by which information may be processed. These information technology systems may be used to collect data for later retrieval, analysis, and manipulation, which may be facilitated through a database program. These information technology systems provide interfaces that allow users to access and operate various system components.

In one embodiment, the CMN controller 2201 maybe connected to and/or communicate with entities such as, but not limited to: one or more users from user input devices 2211; peripheral devices 2212; an optional cryptographic processor device 2228; and/or a communications network 2213.

Networks are commonly thought to comprise the interconnection and interoperation of clients, servers, and intermediary nodes in a graph topology. It should be noted that the term “server” as used throughout this application refers generally to a computer, other device, program, or combination thereof that processes and responds to the requests of remote users across a communications network. Servers serve their information to requesting “clients.” The term “client” as used herein refers generally to a computer, program, other device, user and/or combination thereof that is capable of processing and making requests and obtaining and processing any responses from servers across a communications network. A computer, other device, program, or combination thereof that facilitates, processes information and requests, and/or furthers the passage of information from a source user to a destination user is commonly referred to as a “node.” Networks are generally thought to facilitate the transfer of information from source points to destinations. A node specifically tasked with furthering the passage of information from a source to a destination is commonly called a “router.” There are many forms of networks such as Local Area Networks (LANs), Pico networks, Wide Area Networks (WANs), Wireless Networks (WLANs), etc. For example, the Internet is generally accepted as being an interconnection of a multitude of networks whereby remote clients and servers may access and interoperate with one another.

The CMN controller 2201 may be based on computer systems that may comprise, but are not limited to, components such as: a computer systemization 2202 connected to memory 2229.

### Computer Systemization

A computer systemization 2202 may comprise a clock 2230, central processing unit (“CPU(s)” and/or “processor(s)” (these terms are used interchangeable throughout the disclosure unless noted to the contrary)) 2203, a memory 2229 (e.g., a read only memory (ROM) 2206, a random access memory (RAM) 2205, etc.), and/or an interface bus 2207, and most frequently, although not necessarily, are all interconnected and/or communicating through a system bus 2204 on one or more (mother)board(s) 2202 having conductive and/or otherwise transportive circuit pathways through which instructions (e.g., binary encoded signals) may travel to effectuate communications, operations, storage, etc. The computer systemization may be connected to a power source 2286; e.g., optionally the power source may be internal. Optionally, a cryptographic processor 2226 and/or transceivers (e.g., ICs) 2274 may be connected to the system bus. In another embodiment, the cryptographic processor and/or transceivers may be connected as either internal and/or external peripheral devices 2212 via the interface bus I/O. In turn, the transceivers may be connected to antenna(s) 2275, thereby effectuating wireless transmission and reception of various communication and/or sensor protocols; for example the antenna(s) may connect to: a Texas Instruments WiLink WL1283 transceiver chip (e.g., providing 802.11n Bluetooth 3.0, FM, global positioning system (GPS) (thereby allowing CMN controller to determine its location)); Broadcom BCM4329FKUBG transceiver chip (e.g., providing 802.11n, Bluetooth 2.1+EDR, FM, etc.); a Broadcom BCM4750IUB8 receiver chip (e.g., GPS); an Infineon Technologies X-Gold 618-PMB9800 (e.g., providing 2G/3G HSDPA/HSUPA communications); and/or the like. The system clock typically has a crystal oscillator and generates a base signal through the computer systemization's circuit pathways. The clock is typically coupled to the system bus and various clock multipliers that will increase or decrease the base operating frequency for other components interconnected in the computer systemization. The clock and various components in a computer systemization drive signals embodying information throughout the system. Such transmission and reception of instructions embodying information throughout a computer systemization may be commonly referred to as communications. These communicative instructions may further be transmitted, received, and the cause of return and/or reply communications beyond the instant computer systemization to: communications networks, input devices, other computer systemizations, peripheral devices, and/or the like. It should be understood that in alternative embodiments, any of the above components may be connected directly to one another, connected to the CPU, and/or organized in numerous variations employed as exemplified by various computer systems.

The CPU comprises at least one high-speed data processor adequate to execute program components for executing user and/or system-generated requests. Often, the processors themselves will incorporate various specialized processing units, such as, but not limited to: integrated system (bus) controllers, memory management control units, floating point units, and even specialized processing sub-units like graphics processing units, digital signal processing units, and/or the like. Additionally, processors may include internal fast access addressable memory, and be capable of mapping and addressing memory 2229 beyond the processor itself; internal memory may include, but is not limited to: fast registers, various levels of cache memory (e.g., level 1, 2, 3, etc.), RAM, etc. The processor may access this memory through the use of a memory address space that is accessible via instruction address, which the processor can construct and decode allowing it to access a circuit path to a specific memory address space having a memory state. The CPU may be a microprocessor such as: AMD's Athlon, Duron and/or Opteron; ARM's application, embedded and secure processors; IBM and/or Motorola's DragonBall and PowerPC; IBM's and Sony's Cell processor; Intel's Celeron, Core (2) Duo, Itanium, Pentium, Xeon, and/or XScale; and/or the like processor(s). The CPU interacts with memory through instruction passing through conductive and/or transportive conduits (e.g., (printed) electronic and/or optic circuits) to execute stored instructions (i.e., program code) according to conventional data processing techniques. Such instruction passing facilitates communication within the CMN controller and beyond through various interfaces. Should processing requirements dictate a greater amount speed and/or capacity, distributed processors (e.g., Distributed CMN), mainframe, multi-core, parallel, and/or super-computer architectures may similarly be employed. Alternatively, should deployment requirements dictate greater portability, smaller Personal Digital Assistants (PDAs) maybe employed.

Depending on the particular implementation, features of the CMN may be achieved by implementing a microcontroller such as CAST's R8051XC2 microcontroller; Intel's MCS 51 (i.e., 8051 microcontroller); and/or the like. Also, to implement certain features of the CMN, some feature implementations may rely on embedded components, such as: Application-Specific Integrated Circuit (“ASIC”), Digital Signal Processing (“DSP”), Field Programmable Gate Array (“FPGA”), and/or the like embedded technology. For example, any of the CMN component collection (distributed or otherwise) and/or features may be implemented via the microprocessor and/or via embedded components; e.g., via ASIC, coprocessor, DSP, FPGA, and/or the like. Alternately, some implementations of the CMN may be implemented with embedded components that are configured and used to achieve a variety of features or signal processing.

Depending on the particular implementation, the embedded components may include software solutions, hardware solutions, and/or some combination of both hardware/software solutions. For example, CMN features discussed herein may be achieved through implementing FPGAs, which are a semiconductor devices containing programmable logic components called “logic blocks”, and programmable interconnects, such as the high performance FPGA Virtex series and/or the low cost Spartan series manufactured by Xilinx. Logic blocks and interconnects can be programmed by the customer or designer, after the FPGA is manufactured, to implement any of the CMN features. A hierarchy of programmable interconnects allow logic blocks to be interconnected as needed by the CMN system designer/administrator, somewhat like a one-chip programmable breadboard. An FPGA's logic blocks can be programmed to perform the operation of basic logic gates such as AND, and XOR, or more complex combinational operators such as decoders or mathematical operations. In most FPGAs, the logic blocks also include memory elements, which may be circuit flip-flops or more complete blocks of memory. In some circumstances, the CMN may be developed on regular FPGAs and then migrated into a fixed version that more resembles ASIC implementations. Alternate or coordinating implementations may migrate CMN controller features to a final ASIC instead of or in addition to FPGAs. Depending on the implementation all of the aforementioned embedded components and microprocessors may be considered the “CPU” and/or “processor” for the CMN.

### Power Source

The power source 2286 may be of any standard form for powering small electronic circuit board devices such as the following power cells: alkaline, lithium hydride, lithium ion, lithium polymer, nickel cadmium, solar cells, and/or the like. Other types of AC or DC power sources may be used as well. In the case of solar cells, in one embodiment, the case provides an aperture through which the solar cell may capture photonic energy. The power cell 2286 is connected to at least one of the interconnected subsequent components of the CMN thereby providing an electric current to all subsequent components. In one example, the power source 2286 is connected to the system bus component 2204. In an alternative embodiment, an outside power source 2286 is provided through a connection across the I/O 2208 interface. For example, a USB and/or IEEE 1394 connection carries both data and power across the connection and is therefore a suitable source of power.

### Interface Adapters

Interface bus(ses) 2207 may accept, connect, and/or communicate to a number of interface adapters, conventionally although not necessarily in the form of adapter cards, such as but not limited to: input output interfaces (I/O) 2208, storage interfaces 2209, network interfaces 2210, and/or the like. Optionally, cryptographic processor interfaces 2227 similarly may be connected to the interface bus. The interface bus provides for the communications of interface adapters with one another as well as with other components of the computer systemization. Interface adapters are adapted for a compatible interface bus. Interface adapters conventionally connect to the interface bus via a slot architecture. Conventional slot architectures may be employed, such as, but not limited to: Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and/or the like.

Storage interfaces 2209 may accept, communicate, and/or connect to a number of storage devices such as, but not limited to: storage devices 2214, removable disc devices, and/or the like. Storage interfaces may employ connection protocols such as, but not limited to: (Ultra) (Serial) Advanced Technology Attachment (Packet Interface) ((Ultra) (Serial) ATA(PI)), (Enhanced) Integrated Drive Electronics ((E)IDE), Institute of Electrical and Electronics Engineers (IEEE) 1394, fiber channel, Small Computer Systems Interface (SCSI), Universal Serial Bus (USB), and/or the like.

Network interfaces 2210 may accept, communicate, and/or connect to a communications network 2213. Through a communications network 2213, the CMN controller is accessible through remote clients 2233b (e.g., computers with web browsers) by users 2233a. Network interfaces may employ connection protocols such as, but not limited to: direct connect, Ethernet (thick, thin, twisted pair 10/100/1000 Base T, and/or the like), Token Ring, wireless connection such as IEEE 802.11a-x, and/or the like. Should processing requirements dictate a greater amount speed and/or capacity, distributed network controllers (e.g., Distributed CMN), architectures may similarly be 11 employed to pool, load balance, and/or otherwise increase the communicative bandwidth required by the CMN controller. A communications network may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like. A network interface may be regarded as a specialized form of an input output interface. Further, multiple network interfaces 2210 may be used to engage with various communications network types 2213. For example, multiple network interfaces may be employed to allow for the communication over broadcast, multicast, and/or unicast networks.

Input Output interfaces (I/O) 2208 may accept, communicate, and/or connect to user input devices 2211, peripheral devices 2212, cryptographic processor devices 2228, and/or the like. I/O may employ connection protocols such as, but not limited to: audio: analog, digital, monaural, RCA, stereo, and/or the like; data: Apple Desktop Bus (ADB), IEEE 1394a-b , serial, universal serial bus (USB); infrared; joystick; keyboard; midi; optical; PC AT; PS/2; parallel; radio; video interface: Apple Desktop Connector (ADC), BNC, coaxial, component, composite, digital, Digital Visual Interface (DVI), high-definition multimedia interface (HDMI), RCA, RF antennae, S-Video, VGA, and/or the like; wireless transceivers: 802.11a/b/g/n/x; Bluetooth; cellular (e.g., code division multiple access (CDMA), high speed packet access (HSPA(+)), high-speed downlink packet access (HSDPA), global system for mobile communications (GSM), long term evolution (LTE), WiMax, etc.); and/or the like. One typical output device may include a video display, which typically comprises a Cathode Ray Tube (CRT) or Liquid Crystal Display (LCD) based monitor with an interface (e.g., DVI circuitry and cable) that accepts signals from a video interface, may be used. The video interface composites information generated by a computer systemization and generates video signals based on the composited information in a video memory frame. Another output device is a television set, which accepts signals from a video interface. Typically, the video interface provides the composited video information through a video connection interface that accepts a video display interface (e.g., an RCA composite video connector accepting an RCA composite video cable; a DVI connector accepting a DVI display cable, etc.).

User input devices 2211 often are a type of peripheral device 512 (see below) and may include: card readers, dongles, finger print readers, gloves, graphics tablets, joysticks, keyboards, microphones, mouse (mice), remote controls, retina readers, touch screens (e.g., capacitive, resistive, etc.), trackballs, trackpads, sensors (e.g., accelerometers, ambient light, GPS, gyroscopes, proximity, etc.), styluses, and/or the like.

Peripheral devices 2212 may be connected and/or communicate to I/O and/or other facilities of the like such as network interfaces, storage interfaces, directly to the interface bus, system bus, the CPU, and/or the like. Peripheral devices may be external, internal and/or part of the CMN controller. Peripheral devices may include: antenna, audio devices (e.g., line-in, line-out, microphone input, speakers, etc.), cameras (e.g., still, video, webcam, etc.), dongles (e.g., for copy protection, ensuring secure transactions with a digital signature, and/or the like), external processors (for added capabilities; e.g., crypto devices 528), force-feedback devices (e.g., vibrating motors), network interfaces, printers, scanners, storage devices, transceivers (e.g., cellular, GPS, etc.), video devices (e.g., goggles, monitors, etc.), video sources, visors, and/or the like. Peripheral devices often include types of input devices (e.g., cameras).

It should be noted that although user input devices and peripheral devices may be employed, the CMN controller may be embodied as an embedded, dedicated, and/or monitor-less (i.e., headless) device, wherein access would be provided over a network interface connection.

Cryptographic units such as, but not limited to, microcontrollers, processors 2226, interfaces 2227, and/or devices 2228 may be attached, and/or communicate with the CMN controller. A MC68HC16 microcontroller, manufactured by Motorola Inc., may be used for and/or within cryptographic units. The MC68HC16 microcontroller utilizes a 16-bit multiply-and-accumulate instruction in the MHz configuration and requires less than one second to perform a 512-bit RSA private key operation. Cryptographic units support the authentication of communications from interacting agents, as well as allowing for anonymous transactions. Cryptographic units may also be configured as part of the CPU. Equivalent microcontrollers and/or processors may also be used. Other commercially available specialized cryptographic processors include: Broadcom's CryptoNetX and other Security Processors; nCipher's nShield; SafeNet's Luna PCI (e.g., 7100) series; Semaphore Communications' 40 MHz Roadrunner 184; Sun's Cryptographic Accelerators (e.g., Accelerator 6000 PCIe Board, Accelerator 500 Daughtercard); Via Nano Processor (e.g., L2100, L2200, U2400) line, which is capable of performing 500+MB/s of cryptographic instructions; VLSI Technology's 33 MHz 6868; and/or the like.

### Memory

Generally, any mechanization and/or embodiment allowing a processor to affect the storage and/or retrieval of information is regarded as memory 2229. However, memory is a fungible technology and resource, thus, any number of memory embodiments may be employed in lieu of or in concert with one another. It is to be understood that the CMN controller and/or a computer systemization may employ various forms of memory 2229. For example, a computer systemization may be configured wherein the operation of on-chip CPU memory (e.g., registers), RAM, ROM, and any other storage devices are provided by a paper punch tape or paper punch card mechanism; however, such an embodiment would result in an extremely slow rate of operation. In a typical configuration, memory 2229 will include ROM 2206, RAM 2205, and a storage device 2214. A storage device 2214 may be any conventional computer system storage. Storage devices may include a drum; a (fixed and/or removable) magnetic disk drive; a magneto-optical drive; an optical drive (i.e., Blueray, CD ROM/RAM/Recordable (R)/ReWritable (RW), DVD R/RW, HD DVD R/RW etc.); an array of devices (e.g., Redundant Array of Independent Disks (RAID)); solid state memory devices (USB memory, solid state drives (SSD), etc.); other processor-readable storage mediums; and/or other devices of the like. Thus, a computer systemization generally requires and makes use of memory.

### Component Collection

The memory 2229 may contain a collection of program and/or database components and/or data such as, but not limited to: operating system component(s) 2215 (operating system); information server component(s) 2216 (information server); user interface component(s) 2217 (user interface); Web browser component(s) 2218 (Web browser); database(s) 2219; mail server component(s) 2221; mail client component(s) 2222; cryptographic server component(s) 2220 (cryptographic server); the CMN component(s) 2235; CIU component 2241; SETG component 2242; and/or the like (i.e., collectively a component collection). These components may be stored and accessed from the storage devices and/or from storage devices accessible through an interface bus. Although non-conventional program components such as those in the component collection, typically, are stored in a local storage device 2214, they may also be loaded and/or stored in memory such as: peripheral devices, RAM, remote storage facilities through a communications network, ROM, various forms of memory, and/or the like.

### Operating System

The operating system component 2215 is an executable program component facilitating the operation of the CMN controller. Typically, the operating system facilitates access of I/O, network interfaces, peripheral devices, storage devices, and/or the like. The operating system may be a highly fault tolerant, scalable, and secure system such as: Apple Macintosh OS X (Server); AT&T Plan 9; Be OS; Unix and Unix-like system distributions (such as AT&T's UNIX; Berkley Software Distribution (BSD) variations such as FreeBSD, NetBSD, OpenBSD, and/or the like; Linux distributions such as Red Hat, Ubuntu, and/or the like); and/or the like operating systems. However, more limited and/or less secure operating systems also may be employed such as Apple Macintosh OS, IBM OS/2, Microsoft DOS, Microsoft Windows 2000/2003/3.1/95/98/CE/Millenium/NT/Vista/XP/Win7 (Server), Palm OS, and/or the like. An operating system may communicate to and/or with other components in a component collection, including itself, and/or the like. Most frequently, the operating system communicates with other program components, user interfaces, and/or the like. For example, the operating system may contain, communicate, generate, obtain, and/or provide program component, system, user, and/or data communications, requests, and/or responses. The operating system, once executed by the CPU, may enable the interaction with communications networks, data, I/O, peripheral devices, program components, memory, user input devices, and/or the like. The operating system may provide communications protocols that allow the CMN controller to communicate with other entities through a communications network 2213. Various communication protocols may be used by the CMN controller as a subcarrier transport mechanism for interaction, such as, but not limited to: multicast, TCP/IP, UDP, unicast, and/or the like.

### Information Server

An information server component 2216 is a stored program component that is executed by a CPU. The information server may be a conventional Internet information server such as, but not limited to Apache Software Foundation's Apache, Microsoft's Internet Information Server, and/or the like. The information server may allow for the execution of program components through facilities such as Active Server Page (ASP), ActiveX, (ANSI) (Objective-) C (++), C# and/or .NET, Common Gateway Interface (CGI) scripts, dynamic (D) hypertext markup language (HTML), FLASH, Java, JavaScript, Practical Extraction Report Language (PERL), Hypertext Pre-Processor (PHP), pipes, Python, wireless application protocol (WAP), WebObjects, and/or the like. The information server may support secure communications protocols such as, but not limited to, File Transfer Protocol (FTP); HyperText Transfer Protocol (HTTP); Secure Hypertext Transfer Protocol (HTTPS), Secure Socket Layer (SSL), messaging protocols (e.g., America Online (AOL) Instant Messenger (AIM), Application Exchange (APEX), ICQ, Internet Relay Chat (IRC), Microsoft Network (MSN) Messenger Service, Presence and Instant Messaging Protocol (PRIM), Internet Engineering Task Force's (IETF's) Session Initiation Protocol (SIP), SIP for Instant Messaging and Presence Leveraging Extensions (SIMPLE), open XML-based Extensible Messaging and Presence Protocol (XMPP) (i.e., Jabber or Open Mobile Alliance's (OMA's) Instant Messaging and Presence Service (IMPS)), Yahoo! Instant Messenger Service, and/or the like. The information server provides results in the form of Web pages to Web browsers, and allows for the manipulated generation of the Web pages through interaction with other program components. After a Domain Name System (DNS) resolution portion of an HTTP request is resolved to a particular information server, the information server resolves requests for information at specified locations on the CMN controller based on the remainder of the HTTP request. For example, a request such as http://123.124.125.126/myInformation.html might have the IP portion of the request “123.124.125.126” resolved by a DNS server to an information server at that IP address; that information server might in turn further parse the http request for the “/myInformation.html” portion of the request and resolve it to a location in memory containing the information “myInformation.html.” Additionally, other information serving protocols may be employed across various ports, e.g., FTP communications across port 21, and/or the like. An information server may communicate to and/or with other components in a component collection, including itself, and/or facilities of the like. Most frequently, the information server communicates with the CMN database 2219, operating systems, other program components, user interfaces, Web browsers, and/or the like.

Access to the CMN database may be achieved through a number of database bridge mechanisms such as through scripting languages as enumerated below (e.g., CGI) and through inter-application communication channels as enumerated below (e.g., CORBA, WebObjects, etc.). Any data requests through a Web browser are parsed through the bridge mechanism into appropriate grammars as required by the CMN. In one embodiment, the information server would provide a Web form accessible by a Web browser. Entries made into supplied fields in the Web form are tagged as having been entered into the particular fields, and parsed as such. The entered terms are then passed along with the field tags, which act to instruct the parser to generate queries directed to appropriate tables and/or fields. In one embodiment, the parser may generate queries in standard SQL by instantiating a search string with the proper join/select commands based on the tagged text entries, wherein the resulting command is provided over the bridge mechanism to the CMN as a query. Upon generating query results from the query, the results are passed over the bridge mechanism, and may be parsed for formatting and generation of a new results Web page by the bridge mechanism. Such a new results Web page is then provided to the information server, which may supply it to the requesting Web browser.

Also, an information server may contain, communicate, generate, obtain, and/or provide program component, system, user, and/or data communications, requests, and/or responses.

### User Interface

Computer interfaces in some respects are similar to automobile operation interfaces. Automobile operation interface elements such as steering wheels, gearshifts, and speedometers facilitate the access, operation, and display of automobile resources, and status. Computer interaction interface elements such as check boxes, cursors, menus, scrollers, and windows (collectively and commonly referred to as widgets) similarly facilitate the access, capabilities, operation, and display of data and computer hardware and operating system resources, and status. Operation interfaces are commonly called user interfaces. Graphical user interfaces (GUIs) such as the Apple Macintosh Operating System's Aqua, IBM's OS/2, Microsoft's Windows 27 2000/2003/3.1/95/9 8/CE/Millenium/NT/XP/Vista/7 (i.e., Aero), Unix's X-Windows (e.g., which may include additional Unix graphic interface libraries and layers such as K Desktop Environment (KDE), mythTV and GNU Network Object Model Environment (GNOME)), web interface libraries (e.g., ActiveX, AJAX, (D)HTML, FLASH, Java, JavaScript, etc. interface libraries such as, but not limited to, Dojo, jQuery UI, MooTools, Prototype, script.aculo.us, SWFObject, Yahoo! User Interface, any of which may be used and provide a baseline and means of accessing and displaying information graphically to users.

A user interface component 2217 is a stored program component that is executed by a CPU. The user interface may be a conventional graphic user interface as provided by, with, and/or atop operating systems and/or operating environments such as already discussed. The user interface may allow for the display, execution, interaction, manipulation, and/or operation of program components and/or system facilities through textual and/or graphical facilities. The user interface provides a facility through which users may affect, interact, and/or operate a computer system. A user interface may communicate to and/or with other components in a component collection, including itself, and/or facilities of the like. Most frequently, the user interface communicates with operating systems, other program components, and/or the like. The user interface may contain, communicate, generate, obtain, and/or provide program component, system, user, and/or data communications, requests, and/or responses.

### Web Browser

A Web browser component 2218 is a stored program component that is executed by a CPU. The Web browser may be a conventional hypertext viewing application such as Microsoft Internet Explorer or Netscape Navigator. Secure Web browsing may be supplied with 128 bit (or greater) encryption by way of HTTPS, SSL, and/or the like. Web browsers allowing for the execution of program components through facilities such as ActiveX, AJAX, (D)HTML, FLASH, Java, JavaScript, web browser plug-in APIs (e.g., Firefox, Safari Plug-in, and/or the like APIs), and/or the like. Web browsers and like information access tools may be integrated into PDAs, cellular telephones, and/or other mobile devices. A Web browser may communicate to and/or with other components in a component collection, including itself, and/or facilities of the like. Most frequently, the Web browser communicates with information servers, operating systems, integrated program components (e.g., plug-ins), and/or the like; e.g., it may contain, communicate, generate, obtain, and/or provide program component, system, user, and/or data communications, requests, and/or responses. Also, in place of a Web browser and information server, a combined application may be developed to perform similar operations of both. The combined application would similarly affect the obtaining and the provision of information to users, user agents, and/or the like from the CMN enabled nodes. The combined application may be nugatory on systems employing standard Web browsers.

### Mail Server

A mail server component 2221 is a stored program component that is executed by a CPU 2203. The mail server may be a conventional Internet mail server such as, but not limited to sendmail, Microsoft Exchange, and/or the like. The mail server may allow for the execution of program components through facilities such as ASP, ActiveX, (ANSI) (Objective−) C (++), C# and/or .NET, CGI scripts, Java, JavaScript, PERL, PHP, pipes, Python, WebObjects, and/or the like. The mail server may support communications protocols such as, but not limited to: Internet message access protocol (IMAP), Messaging Application Programming Interface (MAPI)/Microsoft Exchange, post office protocol (POPS), simple mail transfer protocol (SMTP), and/or the like. The mail server can route, forward, and process incoming and outgoing mail messages that have been sent, relayed and/or otherwise traversing through and/or to the CMN.

Access to the CMN mail may be achieved through a number of APIs offered by the individual Web server components and/or the operating system.

Also, a mail server may contain, communicate, generate, obtain, and/or provide program component, system, user, and/or data communications, requests, information, and/or responses.

### Mail Client

A mail client component 2222 is a stored program component that is executed by a CPU 2203. The mail client may be a conventional mail viewing application such as Apple Mail, Microsoft Entourage, Microsoft Outlook, Microsoft Outlook Express, Mozilla, Thunderbird, and/or the like. Mail clients may support a number of transfer protocols, such as: IMAP, Microsoft Exchange, POPS, SMTP, and/or the like. A mail client may communicate to and/or with other components in a component collection, including itself, and/or facilities of the like. Most frequently, the mail client communicates with mail servers, operating systems, other mail clients, and/or the like; e.g., it may contain, communicate, generate, obtain, and/or provide program component, system, user, and/or data communications, requests, information, and/or responses. Generally, the mail client provides a facility to compose and transmit electronic mail messages.

### Cryptographic Server

A cryptographic server component 2220 is a stored program component that is executed by a CPU 2203, cryptographic processor 2226, cryptographic processor interface 2227, cryptographic processor device 2228, and/or the like. Cryptographic processor interfaces will allow for expedition of encryption and/or decryption requests by the cryptographic component; however, the cryptographic component, alternatively, may run on a conventional CPU. The cryptographic component allows for the encryption and/or decryption of provided data. The cryptographic component allows for both symmetric and asymmetric (e.g., Pretty Good Protection (PGP)) encryption and/or decryption. The cryptographic component may employ cryptographic techniques such as, but not limited to: digital certificates (e.g., X.509 authentication framework), digital signatures, dual signatures, enveloping, password access protection, public key management, and/or the like. The cryptographic component will facilitate numerous (encryption and/or decryption) security protocols such as, but not limited to: checksum, Data Encryption Standard (DES), Elliptical Curve Encryption (ECC), International Data Encryption Algorithm (IDEA), Message Digest 5 (MD5, which is a one way hash operation), passwords, Rivest Cipher (RC5), Rijndael, RSA (which is an Internet encryption and authentication system that uses an algorithm developed in 1977 by Ron Rivest, Adi Shamir, and Leonard Adleman), Secure Hash Algorithm (SHA), Secure Socket Layer (SSL), Secure Hypertext Transfer Protocol (HTTPS), and/or the like. Employing such encryption security protocols, the CMN may encrypt all incoming and/or outgoing communications and may serve as node within a virtual private network (VPN) with a wider communications network. The cryptographic component facilitates the process of “security authorization” whereby access to a resource is inhibited by a security protocol wherein the cryptographic component effects authorized access to the secured resource. In addition, the cryptographic component may provide unique identifiers of content, e.g., employing and MD5 hash to obtain a unique signature for an digital audio file. A cryptographic component may communicate to and/or with other components in a component collection, including itself, and/or facilities of the like. The cryptographic component supports encryption schemes allowing for the secure transmission of information across a communications network to enable the CMN component to engage in secure transactions if so desired. The cryptographic component facilitates the secure accessing of resources on the CMN and facilitates the access of secured resources on remote systems; i.e., it may act as a client and/or server of secured resources. Most frequently, the cryptographic component communicates with information servers, operating systems, other program components, and/or the like. The cryptographic component may contain, communicate, generate, obtain, and/or provide program component, system, user, and/or data communications, requests, and/or responses.

### The CMN Database

The CMN database component 2219 may be embodied in a database and its stored data. The database is a stored program component, which is executed by the CPU; the stored program component portion configuring the CPU to process the stored data. The database may be a conventional, fault tolerant, relational, scalable, secure database such as Oracle or Sybase. Relational databases are an extension of a flat file. Relational databases consist of a series of related tables. The tables are interconnected via a key field. Use of the key field allows the combination of the tables by indexing against the key field; i.e., the key fields act as dimensional pivot points for combining information from various tables. Relationships generally identify links maintained between tables by matching primary keys. Primary keys represent fields that uniquely identify the rows of a table in a relational database. More precisely, they uniquely identify rows of a table on the “one” side of a one-to-many relationship.

Alternatively, the CMN database may be implemented using various standard data-structures, such as an array, hash, (linked) list, struct, structured text file (e.g., XML), table, and/or the like. Such data-structures may be stored in memory and/or in (structured) files. In another alternative, an object-oriented database may be used, such as Frontier, ObjectStore, Poet, Zope, and/or the like. Object databases can include a number of object collections that are grouped and/or linked together by common attributes; they may be related to other object collections by some common attributes. Object-oriented databases perform similarly to relational databases with the ii exception that objects are not just pieces of data but may have other types of capabilities encapsulated within a given object. If the CMN database is implemented as a data- structure, the use of the CMN database 2219 may be integrated into another component such as the CMN component 2235. Also, the database may be implemented as a mix of data structures, objects, and relational structures. Databases may be consolidated and/or distributed in countless variations through standard data processing techniques. Portions of databases, e.g., tables, may be exported and/or imported and thus decentralized and/or integrated.

In one embodiment, the database component 2219 includes several tables 2219a-j. A Users table 2219a may include fields such as, but not limited to: user_id, ssn, dob, first_name, last_name, age, state, address_firstline, address_secondline, zipcode, devices_list, contact_info, contact_type, alt_contact_info, alt_contact_type, and/or the like. The Users table may support and/or track multiple entity accounts on a CMN. A Clients table 2219b may include fields such as, but not limited to: client_id, client_name, client_ip, client_type, client_model, operating_system, os_version, app_installed_flag, and/or the like. An Apps table 2219c may include fields such as, but not limited to: app_id, app_name, app_type, os_compatibilities_list, version, timestamp, developer_id, and/or the like. A Devices table 2219d may include fields such as, but not limited to: device_id, user_owner_id, authorized_users_id, privacy_preferences_id, components, last_known_location, location_history, and/or the like. A Device Features table 2219e may include fields such as, but not limited to: device_feature_id, device_id, feature_type, feature_key, feature_value, parent_device_feature_id and/or the like. A Device Locations table 2219f may include fields such as, but not limited to: device_location_id, device_id, time_stamp, lat, lon, alt, temp, humidity, acceleration, g-force_value, gps_signal_summary, cellular_signal_summary, wifi_signal_summary and/or the like. A Privacy Preferences table 2219g may include fields such as, but not limited to: privacy_preference_id, user_id, privacy_level_id, custom_privacy_pref_id, custom_privacy_pref_value, last_updated and/or the like. A Transactions table 2219h may include fields such as, but not limited to: transaction_id, user_id, device_id, device_location_id, trans_amount, trans_receipt, trans_history, coupon, photo_coupon_next_visit, and/or the like. A Media Objects table 2219i may include fields such as, but not limited to: media_object_id, user_id, device_id, is_photo, is_video, is_audio, associated_metadata, child_media_object_ids, parent_media_object_ids, created_timestamp, updated_timestamp, permissions, privacy_preference_id and/or the like. A Media Object Metadata table 2219i may include fields such as, but not limited to: media_object_metadata_id, media_object_id, metadata_key, metadata_value, metadata_keytype, metadata_valuetype, last_updated, permissions, is_multiobjectlink_capable_metadata, and/or the like.

In one embodiment, the CMN database may interact with other database systems. For example, employing a distributed database system, queries and data access by search CMN component may treat the combination of the CMN database, an integrated data security layer database as a single database entity.

In one embodiment, user programs may contain various user interface primitives, which may serve to update the CMN. Also, various accounts may require custom database tables depending upon the environments and the types of clients the CMN may need to serve. It should be noted that any unique fields may be designated as a key field throughout. In an alternative embodiment, these tables have been decentralized into their own databases and their respective database controllers (i.e., individual database controllers for each of the above tables). Employing standard data processing techniques, one may further distribute the databases over several computer systemizations and/or storage devices. Similarly, configurations of the decentralized database controllers may be varied by consolidating and/or distributing the various database components 2219a-j. The CMN may be configured to keep track of various settings, inputs, and parameters via database controllers.

The CMN database may communicate to and/or with other components in a component collection, including itself, and/or facilities of the like. Most frequently, the CMN database communicates with the CMN component, other program components, and/or the like. The database may contain, retain, and provide information regarding other nodes and data.

### The CMNs

The CMN component 2235 is a stored program component that is executed by a CPU. In one embodiment, the CMN component incorporates any and/or all combinations of the aspects of the CMN that was discussed in the previous figures. As such, the CMN affects accessing, obtaining and the provision of information, services, transactions, and/or the like across various communications networks. The features and embodiments of the CMN discussed herein increase network efficiency by reducing data transfer requirements the use of more efficient data structures and mechanisms for their transfer and storage. As a consequence, more data may be transferred in less time, and latencies with regard to transactions, are also reduced. In many cases, such reduction in storage, transfer time, bandwidth requirements, latencies, etc., will reduce the capacity and structural infrastructure requirements to support the CMN's features and facilities, and in many cases reduce the costs, energy consumption/requirements, and extend the life of CMN's underlying infrastructure; this has the added benefit of making the CMN more reliable. Similarly, many of the features and mechanisms are designed to be easier for users to use and access, thereby broadening the audience that may enjoy/employ and exploit the feature sets of the CMN; such ease of use also helps to increase the reliability of the CMN. In addition, the feature sets include heightened security as noted via the Cryptographic components 2220, 2226, 2228 and throughout, making access to the features and data more reliable and secure.

The CMN component may transform user event and media object creation inputs, and/or the like and use the CMN. In one embodiment, the CMN component 2235 takes inputs (e.g., event creation input 207, image cloud transfer request 213, temporal audio input 306, and/or the like) etc., and transforms the inputs via various components (e.g., CUI component 2141, SETG component 2142, and/or the like), into outputs (e.g., image cloud transfer response 214, 312, and/or the like).

The CMN component enabling access of information between nodes may be developed by employing standard development tools and languages such as, but not limited to: Apache components, Assembly, ActiveX, binary executables, (ANSI) (Objective−) C (++), C# and/or .NET, database adapters, CGI scripts, Java, JavaScript, mapping tools, procedural and object oriented development tools, PERL, PHP, Python, shell scripts, SQL commands, web application server extensions, web development environments and libraries (e.g., Microsoft's ActiveX; Adobe AIR, FLEX & FLASH; AJAX; (D)HTML; Dojo, Java; JavaScript; jQuery(UI); MooTools; Prototype; script.aculo.us; Simple Object Access Protocol (SOAP); SWFObject; Yahoo! User Interface; and/or the like), WebObjects, and/or the like. In one embodiment, the CMN server employs a cryptographic server to encrypt and decrypt communications. The CMN component may communicate to and/or with other components in a component collection, including itself, and/or facilities of the like. Most frequently, the CMN component communicates with the CMN database, operating systems, other program components, and/or the like. The CMN may contain, communicate, generate, obtain, and/or provide program component, system, user, and/or data communications, requests, and/or responses.

### Distributed CMNs

The structure and/or operation of any of the CMN node controller components may be combined, consolidated, and/or distributed in any number of ways to facilitate development and/or deployment. Similarly, the component collection may be combined in any number of ways to facilitate deployment and/or development. To accomplish this, one may integrate the components into a common code base or in a facility that can dynamically load the components on demand in an integrated fashion.

The component collection may be consolidated and/or distributed in countless variations through standard data processing and/or development techniques. Multiple instances of any one of the program components in the program component collection may be instantiated on a single node, and/or across numerous nodes to improve performance through load-balancing and/or data-processing techniques. Furthermore, single instances may also be distributed across multiple controllers and/or storage devices; e.g., databases. All program component instances and controllers working in concert may do so through standard data processing communication techniques.

The configuration of the CMN controller will depend on the context of system deployment. Factors such as, but not limited to, the budget, capacity, location, and/or use of the underlying hardware resources may affect deployment requirements and configuration. Regardless of if the configuration results in more consolidated and/or integrated program components, results in a more distributed series of program components, and/or results in some combination between a consolidated and distributed configuration, data may be communicated, obtained, and/or provided. Instances of components consolidated into a common code base from the program component collection may communicate, obtain, and/or provide data. This may be accomplished through intra-application data processing communication techniques such as, but not limited to: data referencing (e.g., pointers), internal messaging, object instance variable communication, shared memory space, variable passing, and/or the like.

If component collection components are discrete, separate, and/or external to one another, then communicating, obtaining, and/or providing data with and/or to other component components may be accomplished through inter-application data processing communication techniques such as, but not limited to: Application Program Interfaces (API) information passage; (distributed) Component Object Model ((D)COM), (Distributed) Object Linking and Embedding ((D)OLE), and/or the like), Common Object Request Broker Architecture (CORBA), Jini local and remote application program interfaces, JavaScript Object Notation (JSON), Remote Method Invocation (RMI), SOAP, process pipes, shared files, and/or the like. Messages sent between discrete component components for inter-application communication or within memory spaces of a singular component for intra-application communication may be facilitated through the creation and parsing of a grammar. A grammar may be developed by using development tools such as lex, yacc, XML, and/or the like, which allow for grammar generation and parsing capabilities, which in turn may form the basis of communication messages within and between components.

For example, a grammar may be arranged to recognize the tokens of an HTTP post command, e.g.:

w3mc-post http:// . . . Value1

where Value1 is discerned as being a parameter because “http://” is part of the grammar syntax, and what follows is considered part of the post value. Similarly, with such a grammar, a variable “Value1” may be inserted into an “http://” post command and then sent. The grammar syntax itself may be presented as structured data that is interpreted and/or otherwise used to generate the parsing mechanism (e.g., a syntax description text file as processed by lex, yacc, etc.). Also, once the parsing mechanism is generated and/or instantiated, it itself may process and/or parse structured data such as, but not limited to: character (e.g., tab) delineated text, HTML, structured text streams, XML, and/or the like structured data. In another embodiment, inter-application data processing protocols themselves may have integrated and/or readily available parsers (e.g., JSON, SOAP, and/or like parsers) that may be employed to parse (e.g., communications) data. Further, the parsing grammar may be used beyond message parsing, but may also be used to parse: databases, data collections, data stores, structured data, and/or the like. Again, the desired configuration will depend upon the context, environment, and requirements of system deployment.

For example, in some implementations, the CMN controller may be executing a PHP script implementing a Secure Sockets Layer (“SSL”) socket server via the information sherver, which listens to incoming communications on a server port to which a client may send data, e.g., data encoded in JSON format. Upon identifying an incoming communication, the PHP script may read the incoming message from the client device, parse the received JSON-encoded text data to extract information from the JSON-encoded text data into PHP script variables, and store the data (e.g., client identifying information, etc.) and/or extracted information in a relational database accessible using the Structured Query Language (“SQL”). An exemplary listing, written substantially in the form of PHP/SQL commands, to accept JSON-encoded input data from a client device via a SSL connection, parse the data to extract variables, and store the data to a database, is provided below:

```
<?PHP
header(′Content-Type: text/plain′);
//set ip address and port to listen to for incoming data
$address = ′192.168.0.100′;
$port = 255;
//create a server-side SSL socket, listen
//for/accept incoming communication
$sock = socket_create(AF_INET, SOCK_STREAM, 0);
socket_bind($sock, $address, $port)
  or die(′Could not bind to address′);
socket_listen($sock);
$client = socket_accept($sock);
//read input data from client device in 1024 byte
//blocks until end of message
do {
    $input = ″″;
    $input = socket_read($client, 1024);
    $data .= $input;
} while($input != ″″);
// parse data to extract variables
$obj = json_decode($data, true);
// store input data in a database
mysql_connect(″10.1.1.1″,$srvr,$pass); // access database server
mysql_select(″CLIENT_DB.SQL″); // select database to append
mysql_query(″INSERT INTO UserTable (transmission) VALUES
($data)″); // add data to UserTable table in a CLIENT database
mysql_close(″CLIENT_DB.SQL″); // close connection to database
?>
```

Also, the following resources may be used to provide example embodiments regarding SOAP parser implementation:

http://www.xav.com/perl/site/lib/SOAP/Parser.html
http://publib.boulder.ibm.com/infocenter/tivihelp/v2r1/index.jsp?
topic=/com.ibm.IBMDI.doc/referenceguide295.htm

and other parser implementations:

http://publib.boulder.ibm.com/infocenter/tivihelp/v2r1/index.jsp?
topic=/com.ibm.IBMDI.doc/referenceguide259.htm

all of which are hereby expressly incorporated by reference.

In order to address various issues and advance the art, the entirety of this application for CMN (including the Cover Page, Title, Headings, Field, Background, Summary, Brief Description of the Drawings, Detailed Description, Claims, Abstract, Figures, Appendices, and otherwise) shows, by way of illustration, various embodiments in which the claimed innovations may be practiced. The advantages and features of the application are of a representative sample of embodiments only, and are not exhaustive and/or exclusive. They are presented only to assist in understanding and teach the claimed principles. It should be understood that they are not representative of all claimed innovations. As such, certain aspects of the disclosure have not been discussed herein. That alternate embodiments may not have been presented for a specific portion of the innovations or that further undescribed alternate embodiments may be available for a portion is not to be considered a disclaimer of those alternate embodiments. It will be appreciated that many of those undescribed embodiments incorporate the same principles of the innovations and others are equivalent. Thus, it is to be understood that other embodiments may be utilized and functional, logical, operational, organizational, structural and/or topological modifications may be made without departing from the scope and/or spirit of the disclosure. As such, all examples and/or embodiments are deemed to be non-limiting throughout this disclosure. Also, no inference should be drawn regarding those embodiments discussed herein relative to those not discussed herein other than it is as such for purposes of reducing space and repetition. For instance, it is to be understood that the logical and/or topological structure of any combination of any program components (a component collection), other components and/or any present feature sets as described in the figures and/or throughout are not limited to a fixed operating order and/or arrangement, but rather, any disclosed order is exemplary and all equivalents, regardless of order, are contemplated by the disclosure. Furthermore, it is to be understood that such features are not limited to serial execution, but rather, any number of threads, processes, services, servers, and/or the like that may execute asynchronously, concurrently, in parallel, simultaneously, synchronously, and/or the like are contemplated by the disclosure. As such, some of these features may be mutually contradictory, in that they cannot be simultaneously present in a single embodiment. Similarly, some features are applicable to one aspect of the innovations, and inapplicable to others. In addition, the disclosure includes other innovations not presently claimed. Applicant reserves all rights in those presently unclaimed innovations including the right to claim such innovations, file additional applications, continuations, continuations in part, divisions, and/or the like thereof. As such, it should be understood that advantages, embodiments, examples, functional, features, logical, operational, organizational, structural, topological, and/or other aspects of the disclosure are not to be considered limitations on the disclosure as defined by the claims or limitations on equivalents to the claims. It is to be understood that, depending on the particular needs and/or characteristics of a CMN individual and/or enterprise user, database configuration and/or relational model, data type, data transmission and/or network framework, syntax structure, and/or the like, various embodiments of the CMN, may be implemented that enable a great deal of flexibility and customization. For example, aspects of the CMN may be adapted for restaurant dining, online shopping ,brick-and-mortar shopping, secured information processing, and/or the like. While various embodiments and discussions of the CMN have been directed to electronic purchase transactions, however, it is to be understood that the embodiments described herein may be readily configured and/or customized for a wide variety of other applications and/or implementations.

What is claimed is:

1. A wearable photo capture apparatus, comprising:
at least one sensor element configured to obtain external environment information;
a media capture element configured to create a media object in response to instructions to capture a media object, the media capture element configured to capture the media object in part based on the external environment information from the at least one sensor;
a media processing element configured to create a meta-tag to be associated with the media object based on the external environment information from the at least one sensor; and
a memory operatively coupled to a wireless network element and configured to store the media object and associated meta-tag generated from the meta-tagging of the media object such that a mobile communications device can automatically request the media object when the mobile communications device is connected to the wearable photo capture apparatus via the wireless network element.

2. The apparatus of claim 1, wherein the at least one sensor element is at least one of a vibration sensor, an acceleration sensor, a gyroscope sensor, a temperature sensor, a proximity sensor, a light sensor, or a microphone sensor.

3. The apparatus of claim 1, wherein capturing a media object consists of at least one of taking a picture, recording a video, or recording audio.

4. The apparatus of claim 1, wherein the external environment information from the at least one sensor is used to determine at least one of how or when to capture the media object.

5. The apparatus of claim 1, wherein:
the at least one sensor element is at least one of a motion, an acceleration sensor, or a gyroscope sensor, and the media capture element is responsive to motion detected by the at least one sensor element to capture the media object when an amount of motion or acceleration detected is below a predetermined threshold.

6. The apparatus of claim 1, wherein:
the at least one sensor element is at least one of a motion sensor, an acceleration sensor, or a gyroscope sensor, and
the media capture element is responsive to motion detected by the at least one sensor element to delay capture of the media object when an amount of motion and/or acceleration detected is above a predetermined threshold.

7. The apparatus of claim 1, wherein the external environment information is information about motion, light, sound, temperature, humidity, or other objects, detected by the at least one sensor element.

8. The apparatus of claim 1, wherein the media processing element is further configured to append the metadata to the media object, the metadata being at least one of a timestamp, an altitude, a geolocation, information about network signals detected near the geolocation, or configuration settings at the time the media object was captured.

9. The apparatus of claim 1, wherein the instructions to capture the media object are received from the mobile communications device via a network connection to the mobile communications device.

10. The apparatus of claim 1, wherein the instructions to capture the media object are received from the mobile communications device via a network connection to a cloud server.

11. The apparatus of claim 1, further comprising:
a magnetic clip attached to a housing enclosing the wearable photo capture apparatus, the magnetic clip configured to attach the wearable photo capture apparatus to an article of clothing.

12. A processor implemented method of generating media content, comprising:
receiving via processor a signal from a wearable photo capture device indicating that the wearable photo capture device has captured a plurality of media objects , the plurality of media objects having associated therewith sensor metadata;
establishing a network connection with the wearable photo capture device in response to the signal;
retrieving the plurality of media objects from the wearable photo capture device;
applying one or more meta-tags to each of the plurality of media objects using at least one of user data and contextual media data;
storing the plurality of media objects, sensor metadata, and meta-tags in memory;
establishing a network connection with a cloud database; and
forwarding the plurality of media objects and meta-tags to the cloud database such that the cloud database stores the plurality of media objects and meta-tags in memory.

13. The method of claim 12, wherein the sensor metadata is information about motion, light, sounds, temperatures, humidity, or other objects, detected by at least one sensor element on the wearable photo capture device.

14. The method of claim 12, wherein the network connection is one of a local network connection over Bluetooth, or an internet connection over one of a Wi-Fi connection or a cellular network connection.

15. The method of claim 12, wherein the user data is at least one of an identifier, a username, or mobile communications device information.

16. The method of claim 12, wherein:
the contextual media data being at least one of global positioning system (GPS) data, or information generated by an image recognition module, and
the information generated by an image recognition module being keywords associated with at least one of a location, a building, a person, an animal, a season, or weather detected within the media object by the image recognition module.

17. The method of claim 12, further comprising:
sending an instruction via the processor to the wearable photo capture device instructing the wearable photo capture device to automatically delete the plurality of media objects from a memory on the wearable photo capture device in response to the plurality of media objects being retrieved from the wearable photo capture device.

18. The method of claim 12, wherein each of the plurality of media objects is one of a picture, a video, or an audio clip.

19. The method of claim 12, further comprising:
displaying via a display module, a media object preview window within a viewfinder interface on a mobile communications device;
receiving via the processor, instructions from a user via the viewfinder interface to capture content displayed in the media object preview window; and
sending via the processor, a signal to the wearable photo capture device including the instructions to capture the content displayed in the media object preview window.

20. The method of claim 12, wherein the plurality of media objects is a first plurality of media objects, the method further comprising:
establishing a network connection with a second wearable photo capture device;
retrieving a second plurality of media objects from the second wearable photo capture device;
applying one or more meta-tags to each of the plurality of media objects; and
forwarding the second plurality of media objects and the associated meta-tags to the cloud database such that the cloud database stores the second plurality of media objects and associated meta-tags in memory.

21. A method of capturing media objects, the method comprising:
receiving a signal from a user to capture a media object;
obtaining sensor data from at least one sensor element, the at least one sensor being one of a light sensor or a motion sensor;
determining a media capture state based on the sensor data from the at least one sensor element;
when the media capture state is positive:
capturing the media object based using the sensor data;
meta-tagging the media object with the sensor data and media object metadata;
storing the media object in a local memory;
sending a signal to one of a mobile communications device or a cloud server indicating the media object has been stored, such that the mobile communications device or the cloud server requests the media object; and
deleting the media object from the local memory when the media object has been sent.

22. The method of claim 21, further comprising:
delaying capturing the media object when the media capture state is negative;
obtaining additional sensor data from the at least one sensor element;
determining a second media capture state based on the additional sensor data from the at least one sensor element;
when the second media capture state is positive:
capturing the media object based using the sensor data;
meta-tagging the media object with the sensor data and media object metadata; and
storing the media object in the local memory such that the mobile communications device can automatically request the media object; and
delaying capturing the media object when the second media capture state is negative.

23. The method of claim 21, wherein capturing the media object based on using the sensor data includes using the sensor data to automatically correct errors caused by external environmental factors during the capture of the media object.

24. The method of claim 21, wherein the sensor data is at least one of light sensor data, accelerometer sensor data, gyroscope sensor data, or vibration sensor data.

25. The method of claim 21, wherein the media object metadata is at least one of a timestamp, an altitude, a geolocation, information about network signals detected near the geolocation, or configuration settings at the time the media object was captured.
